(19) United States
(12) Patent Application Publication
(10) Pub. No.: US 2024/0300158 A1
(43) Pub. Date: Sep. 12, 2024

(54) FILM AND METHOD

(71) Applicant: GREAT WRAP PTY LTD, Victoria (AU)

(72) Inventor: Jordan Kay, Portsea (AU)

(21) Appl. No.: 18/283,969

(22) PCT Filed: Mar. 28, 2022
(86) PCT No.: PCT/AU2022/050279

§ 371 Date: Sep. 25, 2023

(30) Foreign Application Priority Data
Mar. 26, 2021 (AU) 2021900904

(51) Int. Cl. B29C 48/21; B29K 67/00; B29K 105/00

(52) U.S. Cl. CPC B29C 48/21; B29K 2003/00; B29K 2067/006; B29K 2105/0088; B29K 2995/0097

(57) ABSTRACT

The present disclosure generally relates to films, such as multilayered films, that are suitable for use as stretch wraps, cling wraps and/or pallet wraps which according to some examples are compostable and/or biodegradable whilst maintaining stretch and cling properties. In particular, the films described herein comprise one or more film layers comprising a blend of starch-based thermoplastic resin and polybutylene adipate terephthalate (PBAT). The present disclosure is also directed to processes for preparing the films described herein.

### FIELD

The present disclosure relates to films suitable for use as stretch wraps, cling wraps and/or pallet wraps. In particular the present disclosure relates to films that are compostable and/or biodegradable whilst maintaining stretch and cling properties. The present disclosure is also directed to processes for preparing the films described herein.

### BACKGROUND

Plastic waste remains a growing problem in modern society. Despite recent efforts to reduce, reuse and recycle, over 150 million tons of plastic is used once and thrown away each year globally. Australian consumers use 150,000 tons of cling wrap and pallet wrap every year, and millions of tons globally. To reduce this heavy environmental impact, there is a need for alternative or improved films, for example stretch wraps and pallet wraps, that are biodegradable and/or compostable.

It will be understood that any prior art publications referred to herein do not constitute an admission that any of these documents form part of the common general knowledge in the art, in Australia or in any other country.

### SUMMARY

The present inventors have undertaken research and development into films that can be used as a wrap (e.g. stretch wrap, pallet wrap etc.) that are biodegradable and/or compostable whilst maintaining excellent stretch and/or adhesion properties. In particular, the present inventors have identified that by incorporating one or more materials into the film, various properties can be improved, including enhancing the films compostable and/or biodegradable properties whilst retaining good elasticity, adhesion and/or strength. The present disclosure described herein can also be scalable for industrial application, and may find use particularly in the packaging of commercial pallets (i.e. a pallet wrap) and household stretch wraps.

The film can comprise a starch-based thermoplastic resin. The film can comprise polybutylene adipate terephthalate (PBAT). The film can comprise a blend of the starch-based thermoplastic resin and polybutylene adipate terephthalate (PBAT). The ratio of the starch-based thermoplastic resin to PBAT can be tuned to provide the film with biodegradable/compostable properties. The blend may comprise a high ratio of starch-based thermoplastic resin to polybutylene adipate terephthalate (PBAT). It has been surprisingly found that films comprising a high ratio of starch-based thermoplastic resin to polybutylene adipate terephthalate (PBAT) provides one or more advantages including excellent biodegradable and/or compostable properties, elasticity (i.e. elongation) and cling properties. Additionally, by preparing films using a blend of PBAT with a high amount of starch-based thermoplastic resin, the overall oil petroleum component in the film is diluted which leads to a more sustainable alternative.

In one aspect, there is provided a film comprising a blend having a high ratio of starch-based thermoplastic resin to polybutylene adipate terephthalate (PBAT).

In a related aspect, there is provided a film comprising an extrusion of a blend having a high ratio of starch-based thermoplastic resin to polybutylene adipate terephthalate (PBAT).

In some embodiments, the ratio of the starch-based thermoplastic resin to PBAT may be at least 0.9, for example between about 0.9 to 1.1, including about 1.0 (i.e. 1:1 resin:PBAT). According to some embodiments or examples described herein, the inventors have surprisingly identified that a film comprising a starch-based thermoplastic resin and PBAT at a ratio of at least 0.9 resulted in a film with excellent compostable properties whilst retaining good elasticity, adhesion and/or strength.

According to at least some embodiments or examples described herein, the present inventors have surprisingly identified that a film extruded from a blend having such a high ratio (e.g. 0.9 or greater) of starch-based thermoplastic resin to PBAT had good elongation at break properties (e.g. up to 500% or more). This was unexpected given that blending PBAT with the starch-based thermoplastic resin at such high ratios should have significantly reduced the films elongation at break properties. To elaborate more, PBAT alone is inherently extremely elastomeric due to a high elongation at break (e.g. greater than 400%), and stretches significantly. In contrast, starch-based thermoplastic resin (TPS) is inherently rigid stiff and have a low elongation at break (e.g. less than 10%), is brittle and high moisture sensitivity which limit the applications in films. It is for this reason that TPS is often down blended with other biodegradable plastics (such as PBAT) to lower the amount of TPS present in the final film. For example, when looking to manufacture biodegradable films using a blend of TPS and

PBAT, product manufacturing process notes emphasise that the amount of TPS in the blend must be down blended during the film blowing stage to arrive at a ratio of TPS to BPAT of 0.8 or less (e.g. about 40% TPS). Based on these industry guidelines, extruding blends comprising a high ratio of TPS to PBAT (e.g. at ratios of at least 0.9) according to the present disclosure would have been expected to produce rigid, non-stretchy and stiff films, and not one having a high % of elongation at break. As a result, the films of the present disclosure are stretchy and flexible, and can be used to wrap a variety of goods, including as a cling film and/or pallet wrap.

Additionally, by significantly increasing the amount of TPS in the blend used to prepare the films, the present inventors have further identified that films prepared using a blend comprising a high ratio of TPS to PBAT completely disintegrated under composting conditions in half the time required (e.g. ˜ 90 days compared to the maximum 180 days required by one or more testing standards, such as ASTM D6400, according to at least some embodiments or examples described herein. Importantly, the films structural integrity remained (e.g. retained good elasticity and strength properties) allowing it to efficiently wrap and protect goods (e.g. as a pallet wrap). Other advantages are also described herein.

The film may be a layer in a multilayered film. The multilayered film may comprise a first film layer comprising a blend of the starch-based thermoplastic resin and polybutylene adipate terephthalate (PBAT) and a second film layer. The second film layer may comprise or consist of a biopolymer (e.g. polybutylene succinate (PBS). Alternatively, the second film layer may comprises or consist of polybutylene adipate terephthalate (PBAT).

In one embodiment, there is provided a film comprising a blend of a starch-based thermoplastic resin and polybutylene adipate terephthalate (PBAT), wherein the ratio of the starch-based thermoplastic resin to PBAT in the blend is at least 0.9.

In one embodiment, the ratio of the starch-based thermoplastic resin to PBAT in the blend is between about 0.9 to 2.0. In one embodiment, the ratio of the starch-based thermoplastic resin to PBAT in the blend is about 1.0.

In another aspect, there is provided a multilayered film comprising at least a first film layer comprising a blend of a starch-based thermoplastic resin and polybutylene adipate terephthalate (PBAT) and a second film layer. In one embodiment, the second film layer may comprise or consist of a biopolymer (e.g. polybutylene succinate (PBS)). Alternatively, the second film layer may comprise or consist of polybutylene adipate terephthalate (PBAT).

In one embodiment, the multilayered film comprises at least a first film layer comprising or consisting of a blend of a starch-based thermoplastic resin and polybutylene adipate terephthalate (PBAT) and a second film layer comprising or consisting of polybutylene adipate terephthalate (PBAT). In one embodiment, the first film layer is a core film layer comprising or consisting of a blend of a starch-based thermoplastic resin and polybutylene adipate terephthalate (PBAT), wherein the core film layer is coated on opposing sides with the second film layer. The second film layer may consist of polybutylene adipate terephthalate (PBAT) and optionally one or more additives.

In another aspect, there is provided a multilayered film comprising:

a) a first outer film layer comprising or consisting of polybutylene adipate terephthalate (PBAT); b) a second outer film layer comprising or consisting of polybutylene adipate terephthalate (PBAT); and c) at least one inner film layer located between the first outer film layer and the second outer film layer, the inner film layer comprising a blend of a starch-based thermoplastic resin and polybutylene adipate terephthalate (PBAT).

In another aspect, there is provided a multilayered film comprising:
a) a first outer film layer comprising or consisting of a biopolymer (e.g. polybutylene succinate (PBS)); b) a second outer film layer comprising or consisting of a biopolymer (e.g. polybutylene succinate (PBS)); and c) at least one inner film layer located between the first outer film layer and the second outer film layer, the inner film layer comprising or consisting of a blend of a starch-based thermoplastic resin and polybutylene adipate terephthalate (PBAT).

In another aspect, there is provided a multilayered film comprising at least five film layers having the structure ABABA, wherein A is a film layer comprising or consisting of a biopolymer and B is a film layer comprising or consisting of a blend of a starch-based thermoplastic resin and polybutylene adipate terephthalate (PBAT). Alternatively, A may be a film layer comprising or consisting of polybutylene adipate terephthalate (PBAT).

In another aspect, there is provided a multilayered film comprising at least five film layers having the structure ABABA, wherein A is a film layer comprising or consisting of polybutylene adipate terephthalate (PBAT) and B is a film layer comprising or consisting of a blend of a starch-based thermoplastic resin and polybutylene adipate terephthalate (PBAT). In one embodiment, the multilayered film comprises at least five film layers having the structure ABABA, wherein each A film layer comprising or consisting of PBAT may independently make up between about 5% to about 15% w/w of the multilayered film, and each B film layer comprising or consisting of a blend of starch-based thermoplastic resin and PBAT independently makes up between about 30% w/w to about 50% w/w of the multilayered film. I

In another aspect, there is provided a multilayered film comprising at least five film layers having the structure ABABA, wherein A is a film layer comprising or consisting of about 10% w/w polybutylene adipate terephthalate (PBAT) and B is film layer comprising or consisting of about 35% w/w of a blend of a starch-based thermoplastic resin and polybutylene adipate terephthalate (PBAT), based on the weight of the multilayered film.

In another aspect, there is provided a film consisting of a blend of a starch-based thermoplastic resin and polybutylene adipate terephthalate (PBAT), and optionally one or more additives, wherein the ratio of the starch-based thermoplastic resin to PBAT in the blend is between about 0.9 to about 2.0.

In another aspect, there is provided a multilayered film comprising at least a first film layer consisting of a blend of a starch-based thermoplastic resin and polybutylene adipate terephthalate (PBAT) and optionally one or more additives, and a second film layer.

In another aspect, there is provided a multilayered film comprising at least a first film layer consisting of a blend of a starch-based thermoplastic resin and polybutylene adipate terephthalate (PBAT) and optionally one or more additives, and a second film layer consisting of polybutylene adipate terephthalate (PBAT) and optionally one or more additives.

In another aspect, there is provided a stretch wrap comprising the film or multilayered film defined above. In another aspect, there is provided a pallet wrap comprising the film or multilayered film defined above. In another aspect, there is provided a cling film comprising the film or multilayered film defined above.

The present disclosure also provides a process for preparing a film described herein. The process comprises heating a starch-based thermoplastic resin and polybutylene adipate terephthalate (PBAT) in an extruder. The heating melts the starch-based thermoplastic resin and polybutylene adipate terephthalate (PBAT) which is then extruded through a die to form a film.

In another aspect, there is provided a process to prepare a film, comprising heating a blend of a starch-based thermoplastic resin and polybutylene adipate terephthalate (PBAT) in an extruder at a temperature effective to melt the blend, and extruding the melted blend through a die to form a film.

It will be appreciated that any one or more of the embodiments and examples described herein for the films may also apply to processes for preparing films. Any embodiment herein shall be taken to apply mutatis mutandis to any other embodiment unless specifically stated. It will also be appreciated that other aspects, embodiments and examples of the films, processes and properties are described herein.

It will also be appreciated that some features of the films and processes identified in some aspects, embodiments or examples as described herein may not be required in all aspects, embodiments or examples as described herein, and this specification is to be read in this context. It will also be appreciated that in the various aspects, embodiments or examples, the order of method or process steps may not be essential and may be varied.

### BRIEF DESCRIPTION OF FIGURES

Preferred embodiments of the present disclosure are further described and illustrated as follows, by way of example only, with reference to the accompanying drawings in which:

FIGS. 1A and B: Photo of a pallet wrap comprising a multilayered film as described herein for wrapping goods;

FIG. 2: Film comprising high ratio of TPS to PBAT disintegrates within 100 day during compositing at ambient temperature. Visual presentation of the contents of a composting reactor with 0.5% cling wrap comprising 1:1 starch-based thermoplastic resin to PBAT (18 μm), cut into 2.5 cm×2.5 cm pieces, after 13 weeks of composting at ambient temperature (=end of the test).

FIG. 3: Plot graphically representing the composting of the film in FIG. 2.

### DETAILED DESCRIPTION

The present disclosure describes the following various non-limiting embodiments, which relate to investigations undertaken to identify films and processes for preparing the same. Additional non-limiting embodiments of the films and processes, their properties and applications are also described. It has been surprisingly found that films comprising a high ratio of starch-based thermoplastic resin to polybutylene adipate terephthalate (PBAT) provides a film with one or more advantages including excellent biodegradable and/or compostable properties, elasticity (i.e. elongation) and cling properties. In particular, the films described herein can also break down into carbon, biomass and water. By preparing films using a blend of PBAT with a high amount of starch-based thermoplastic resin, the overall oil petroleum component in the film is diluted which leads to a more sustainable alternative thereby creating a more bio-based film. In contrast to other films in the prior art purported to be biodegradable, the present disclosure utilises a specific blend comprising a high ratio of starch-based thermoplastic resin to polybutylene adipate terephthalate (PBAT) to prepare films that are cheap, have a low oil petroleum content and carbon footprint, scalable for industrial application, and/or find particular utility as stretch wraps, cling films or pallet wraps owing to their excellent elongation and/or cling properties. Other applications and advantages associated with the films and processes for preparing the same are also described herein.

### Terms

In the following description, reference is made to the accompanying drawings which form a part hereof, and which is shown, by way of illustration, several embodiments. It is understood that other embodiments may be utilized and structural changes may be made without departing from the scope of the present disclosure.

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the term “about”, unless stated to the contrary, typically refers to +/−10%, for example +/−5%, of the designated value.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The reference to “substantially free” generally refers to the absence of that compound or component in the film other than any trace amounts or impurities that may be present, for example this may be an amount by weight % in film of less than about 1%, 0.1%, 0.01%, 0.001%, or 0.0001%. The film compositions described herein may also include, for example, impurities in an amount by weight % in film of less than about 5%, 4%, 3%, 2%, 1%, 0.5%, 0.1%, 0.01%, 0.001%, or 0.0001%. An impurity may be an additive present in the starting materials (e.g. additives used to prepare the starch-based thermoplastic resin or PBAT) used to make the films.

The term “% w/w” refers to weight percentage, for example as a weight percentage of the total weight of the blend, or as a weight percentage of total weight of the film. For example, reference to a multilayered film comprising between about 20% w/w to about 50% w/w of the starch-based thermoplastic resin and between about 50% w/w to about 80% w/w of PBAT, refers to the % w/w amount of the components based on the total weight of the multilayered film.

### Films

The present disclosure is directed to films, including films configured for use as stretch wrap, cling film and pallet wraps. The term “film” as used herein refers to a thin continuous article that includes one or more polymeric materials that can be used to separate areas or volumes, to hold items together, and/or to act as a barrier, e.g. a stretch wrap, cling film or pallet wrap. The films described herein may comprise one or more layers (e.g. film layers). A “layer” or “film layer” refers to a discrete film such as a single extrusion of the blend described herein. Two or more layers may be arranged in the film generally in the form of a plurality of sheets (e.g. coextruded) to form a multilayered film. The term “multilayered film” refers to a plurality of film layers described herein (i.e. two or more layers). The films described herein comprises a starch-based thermoplastic resin and polybutylene adipate terephthalate (PBAT).

The film can be prepared by extruding two or more ingredients, including a starch-based thermoplastic resin and polybutylene adipate terephthalate (PBAT). The film may comprise a suitable amount starch-based thermoplastic resin and polybutylene adipate terephthalate (PBAT), for example in amounts sufficient to be home compostable and/or biodegradable whilst maintaining excellent stretch and cling properties.

In one embodiment, there is provided a film comprising a blend having a high ratio of starch-based thermoplastic resin to polybutylene adipate terephthalate (PBAT). In a related embodiment, there is provided a film comprising an extrusion of a blend having a high ratio of starch-based thermoplastic resin to polybutylene adipate terephthalate (PBAT).

In one embodiment, the film comprises a blend of a starch-based thermoplastic resin and polybutylene adipate terephthalate (PBAT), wherein the ratio of the starch-based thermoplastic resin to PBAT in the blend is at least 0.9.

In some embodiments, the film may comprise between about 30% w/w to about 80% w/w of the starch-based thermoplastic resin and between about 20% w/w to about 70% w/w of PBAT. In some embodiments, the film or blend may comprise between about 45% w/w to about 75% w/w of the starch-based thermoplastic resin and between about 25% w/w to about 55% w/w of PBAT. In some embodiments, the film may comprise between about 45% w/w to about 65% w/w of the starch-based thermoplastic resin and between about 35% w/w to about 55% w/w of PBAT. In some embodiments, the film may comprise between about 45% w/w to about 55% w/w starch-based thermoplastic resin and between about 45% w/w to about 55% w/w of PBAT. In some embodiments, the film may comprise about 50% w/w of the starch based thermoplastic resin, and about 50% w/w of PBAT.

In some embodiments, the film may comprise at least about 30, 35, 40, 45, 50, 55, 60, 65, 70, 75 or 80% w/w of the starch-based thermoplastic resin. In some embodiments, the film may comprise less than about 80, 75, 70, 65, 60, 55, 50, or 45% w/w of the starch-based thermoplastic resin. Combinations of any two of these upper and/or lower values can provide a range selection, for example between about 30% w/w to about 80% w/w, about 45% w/w to about 75% w/w, or about 45% w/w to about 65% w/w of the starch-based thermoplastic resin. In some embodiments, the film comprises about 50% w/w of the starch based thermoplastic resin.

In some embodiments, the film may comprise at least about 20, 25, 30, 35, 40, 45, 50, 55, 60, 65 or 70% w/w of PBAT. In some embodiments, the film may comprise less than about 70, 65, 60, 55, 50, 45, 40, 35, 30, 25 or 20% w/w of PBAT. Combinations of any two of these upper and/or lower values can provide a range selection, for example between about 20% w/w to about 70% w/w, about 25% w/w to about 55% w/w, or about 35% to about 55% w/w of PBAT. In some embodiments, the film comprises about 50% w/w of PBAT.

In some embodiments, the film may comprise between about 45% w/w to about 65% w/w of the starch-based thermoplastic resin and between about 35% w/w to about 55% w/w of PBAT.

It will be appreciated that the above % w/w amounts of starch-based thermoplastic resin and PBAT can be varied to further enhance the films compostability, clinginess and/or stretchiness.

The starch-based thermoplastic resin and PBAT are provided as a blend. The blend is extruded to form the film. The blend comprises the starch-based thermoplastic resin and PBAT. In some cases, blending the starch-based thermoplastic resin with PBAT increases the PBAT's compostable and/or biodegradable properties. The blend may be a homogenous blend.

In some embodiments, the blend may comprise at least about 30, 35, 40, 45, 50, 55, 60, 65 70, 75 or 80% w/w of the starch-based thermoplastic resin. In some embodiments, the blend may comprise less than about 80, 75, 70, 65, 60, 55, 50, 40, 35 or 30% w/w of the starch-based thermoplastic resin. Combinations of any two of these upper and/or lower values can provide a range selection, for example between about 30% w/w to about 80% w/w, about 45% w/w to about 75% w/w, or about 45% w/w to about 65% w/w of the starch-based thermoplastic resin. In some embodiments, the blend comprises about 50% w/w of the starch based thermoplastic resin.

In some embodiments, the blend may comprise at least about 20, 25, 30, 35, 40, 45, 50, 55, 60, 65 or 70, % w/w of PBAT. In some embodiments, the blend may comprise less than about 70, 65, 60, 55, 50, 45, 40, 35, 30, 25 or 20% w/w of PBAT. Combinations of any two of these upper and/or lower values can provide a range selection, for example between about 20% w/w to about 80% w/w, about 25% w/w to about 55% w/w, or about 35% to about 55% w/w of PBAT. In some embodiments, the blend comprises about 50% w/w of PBAT.

In some embodiments, the blend may comprise between about 45% w/w to about 65% w/w of the starch-based thermoplastic resin and between about 35% w/w to about 55% w/w of PBAT.

In a preferred embodiment, the blend comprises a high ratio of the starch-based thermoplastic resin to PBAT. By using a blend comprising a higher ratio of starch-based thermoplastic resin to PBAT, the overall synthetic oil petroleum component in the film is diluted which leads to a more sustainable alternative thereby creating a more bio-based film.

As used herein, the term “high ratio” refers to a ratio of starch-based thermoplastic resin to PBAT in the blend that is in an amount effective to dilute the amount of PBAT present in the blend. For example, a “high ratio” may refer to a blend comprising starch-based thermoplastic resin in an amount similar to or greater than the amount of polybutylene adipate terephthalate (PBAT). In another example, a “high ratio” may refer a blend comprising starch-based thermoplastic resin in an amount equal to or greater than the amount of polybutylene adipate terephthalate (PBAT). In yet another example, a “high ratio” may refer to a ratio of starch-based thermoplastic resin to PBAT in the blend that is of 0.9 or more.

In some embodiments, the ratio of the starch-based thermoplastic resin to PBAT in the blend may be least about 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0. In some embodiments, of the starch-based thermoplastic resin to PBAT in the blend may be less than 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, or 0.9. Combinations of any two of these upper and/or lower ratio values can provide a range selection, for example between about 0.9 to about 3.0, about 0.9 to about 2.0, about 0.9 to about 1.8, about 0.9 to 1.4, or about 0.9 to about 1.1. In one embodiment, the ratio of the starch-based thermoplastic resin to PBAT in the blend may be between about 0.9 to about 2.0. In one embodiment, the ratio of the starch-based thermoplastic resin to PBAT in the blend may be at least about 0.7. In one embodiment, the ratio of the starch-based thermoplastic resin to PBAT in the blend may be at least about 0.9. In one embodiment, the ratio of the starch-based thermoplastic resin to PBAT in the blend may be at least about 1.0. In one embodiment, the ratio of the starch-based thermoplastic resin to PBAT in the blend may be at least about 1.1. In one embodiment, the ratio of the starch-based thermoplastic resin to PBAT in the blend may be at least about 2. In one embodiment, the ratio of the starch-based thermoplastic resin to PBAT in the blend may be between about 0.9 to about 2.0. In one embodiment, the ratio of the starch-based thermoplastic resin to PBAT in the blend may be about 1.0.

It will be appreciated that the above ratios, while in decimal form, can be rewritten in other ways, for example a “:” ratio. In some embodiments, a ratio of 1.0 can be rewritten as 1:1, or 0.9 can be rewritten as 0.9:1. In some embodiments, the ratio of the starch-based thermoplastic resin to PBAT in the blend may be at least about 0.9:1, 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1 or 3:1. In some embodiments, of the starch-based thermoplastic resin to PBAT in the blend may be less than 3:1, 2.9:1, 2.8:1, 2.7:1, 2.6:1, 2.5:1, 2.4:1, 2.3:1, 2.2:1 2.1:1, 2:1, 1.9:1, 1.8:1, 1.7:1, 1.6:1, 1.5:1, 1.4:1, 1.3:1, 1.2:1, 1.1:1, 1:1, or 0.9:1. Combinations of any two of these upper and/or lower ratio values can provide a range selection, for example between about 0.9:1 to about 3:1, about 0.9:1 to about 2:1, about 0.9:1 to about 1.8:1, about 0.9:1 to 1.4:1, or about 0.9:1 to about 1.1:1. In one embodiment, the ratio of the starch-based thermoplastic resin to PBAT in the blend may be between about 0.9:1 to about 1.1:1. In one embodiment, the ratio of the starch-based thermoplastic resin to PBAT in the blend may be at least about 0.9:1. In one embodiment, the ratio of the starch-based thermoplastic resin to PBAT in the blend may be at least about 1:1. In one embodiment, the ratio of the starch-based thermoplastic resin to PBAT in the blend may be at least about 1.1:1. In one embodiment, the ratio of the starch-based thermoplastic resin to PBAT in the blend may be about 1:1.

In particular, the present inventors have identified that a film comprising a blend of starch-based thermoplastic resin and PBAT at a ratio of at least 0.9, preferably between about 0.9 to 2.0, e.g. about 1.0 resulted in a film with excellent elongation and cling properties, tear resistance and/or fast composability. Surprisingly, films comprising such a high ratio (e.g. 0.9 or greater) of starch-based thermoplastic resin to PBAT demonstrated excellent compostable and stretch properties. This was unexpected given that blending PBAT with the starch-based thermoplastic resin at such high ratios should have significantly reduced the elongation at break properties. To elaborate more, PBAT alone is inherently extremely elastomeric due to a high elongation at break (e.g. greater than 400%), and stretches significantly. In contrast, the starch-based thermoplastic resins disclosed herein inherently rigid stiff and have a low elongation at break (e.g. less than 10%). Extruding blends comprising a high ratio of starch-based thermoplastic resin with PBAT (e.g. at ratios of at least 0.9) would have been expected to produce rigid, non-stretchy and stiff films. In contrast, a film with excellent stretch and cling properties was obtained. Additionally, by using a blend comprising a higher ratio of starch-based thermoplastic resin to PBAT, the overall amount of PBAT used to prepare the films can be reduced.

It will be appreciated that the ratio of starch-based thermoplastic resin to polybutylene adipate terephthalate (PBAT) qualifies the amount of starch-based thermoplastic resin to polybutylene adipate terephthalate (PBAT) in the blend, and is independent of amount of other optional additives that may be present in the blend. Additionally, in the case of a multilayered film, comprising at least a first layer comprising a blend of a starch-based thermoplastic resin and polybutylene adipate terephthalate (PBAT) and a second film layer, the ratio of starch-based thermoplastic resin to polybutylene adipate terephthalate (PBAT) qualifies the amount of starch-based thermoplastic resin to polybutylene adipate terephthalate (PBAT) in the first layer, and is independent of the amount of other components present in the second layer, for example. For example, where a film comprising the blend having a high ratio of starch-based thermoplastic resin to polybutylene adipate terephthalate (PBAT) forms one or more layers as part of a multilayered film (e.g. is one or more of a first film layer, third film layer, core film layer, inner film layer, and B film layer as described herein), the ratio of starch-based thermoplastic resin to polybutylene adipate terephthalate (PBAT) in the blend refers to the ratio of starch-based thermoplastic resin to polybutylene adipate terephthalate (PBAT) in the respective film layer or layers comprising the blend, and not to the overall ratio of the starch-based thermoplastic resin to polybutylene adipate terephthalate (PBAT) in the multilayered film. In other words, while the total % w/w of starch-based thermoplastic resin to polybutylene adipate terephthalate (PBAT) in the multilayered film may vary depending on the number of layers, the ratio of starch-based thermoplastic resin to polybutylene adipate terephthalate (PBAT) in the film layer or layers comprising the remains the same.

The film or blend may further comprise a biopolymer. In some embodiments, the film or blend comprises at least about 1, 2, 3, 4, 5, 6, 7, 8, 9, 10, 12, 14, 16, 18 or 20% w/w biopolymer. In some embodiments, the film or blend comprises less than about 20, 18, 16, 14, 12, 10, 9, 8, 7, 6, 5, 4, 3, 2, or 1% w/w biopolymer. Combinations of any two of these upper and/or lower values can provide a range selection, for example between about 5% w/w to about 20% w/w biopolymer. In one embodiment, the film or blend comprises about 10% w/w biopolymer. The biopolymer may be an additional layer on the film (i.e. multilayered film), the blend of starch-based thermoplastic resin and PBAT may further comprise the biopolymer (i.e. single layer film).

The film may comprise a single layer or may comprise two or more layers (e.g. a multilayered film). In some embodiments, the film may comprise at least 1, 2, 3, 4, 5, 6, 7, 8, 9, 10, 12, 15, 20, 25, 30, 40, 50, 70 or 100 layers. In some embodiments, the film may comprise less than about 100, 70, 50, 40, 30, 25, 20, 15, 12, 10, 9, 8, 7, 6, 5, 4, 3 or 2 layers. Combinations of any two of these upper and/or lower values can provide a range selection, for example between about 1 layer to about 20 layers, or about 1 layer to about 10 layers. Where the layers are nanolayers (e.g. layers with a cross-sectional distance of 100 nm or less), it will be appreciated that more than 100 layers may be present.

The film may comprise single layer or may comprise two or more layers (e.g. a multilayered film). In some embodiments, the film or any individual layers may have a thickness (cross-sectional distance) of at least about 0.001, 0.002, 0.004, 0.006, 0.008, 0.01, 0.02, 0.03, 0.05, 0.07, 0.1, 0.2, 0.5, 0.7, 1, 2, 3, 4, 5, 6, 7, 8, 9, or 10 mm. In some embodiments, the film or any individual layers may have a thickness of less than about 10, 9, 8, 7, 6, 5, 4, 3, 2, 1, 0.7, 0.5, 0.2, 0.1, 0.07, 0.05, 0.03, 0.02, 0.01, 0.008, 0.006, 0.004, 0.002 or 0.001 mm. Combinations of any two of these upper and/or lower values can provide a range selection, for example between about 0.001 mm (1 μm) to about 2 mm, about 0.001 mm to about 10 mm, or about 0.001 mm to about 1 mm, or about 0.001 mm to about 0.05 mm. In some embodiments, the film may have a total thickness (cross-sectional distance across the entire film) of at least about 0.001, 0.002, 0.004, 0.006, 0.008, 0.01, 0.02, 0.03, 0.05, 0.07, 0.1, 0.2, 0.5, 0.7, 1, 2, 3, 4, 5, 6, 7, 8, 9, or 10 mm. In some embodiments, the film may have a total combined thickness of less than about 10, 9, 8, 7, 6, 5, 4, 3, 2, 1, 0.7, 0.5, 0.2, 0.1, 0.07, 0.05, 0.03, 0.02, 0.01, 0.008, 0.006, 0.004, 0.002 or 0.001 mm. Combinations of any two of these upper and/or lower values can provide a range selection, for example between about 0.001 mm (1 μm) to about 2 mm, about 0.001 mm to about 10 mm, or about 0.001 mm to about 1 mm, or about 0.001 mm to about 0.05 mm. Other thicknesses are also possible depending on the process parameters used to prepare the films.

The film may be a pallet wrap, cling film and/or stretch wrap. In one embodiment, the film is a cling film or a stretch wrap. It will be appreciated that the embodiments and examples described herein in relation to the film equally apply to pallet wraps, cling films and/or stretch wraps comprising the films.

### Multilayered Films

In one embodiment, the film may be a multilayered film comprising 2 or more layers, for example a multilayered wrap such as a multilayered pallet wrap, stretch wrap or cling film. In some embodiments, the multilayered film may comprise at least 2, 3, 4, 5, 6, 7, 8, 9, 10, 12, 15, 20, 25, 30, 40, 50, 70 or 100 layers. In some embodiments, the multilayered film may comprise less than about 100, 70, 50, 40, 30, 25, 20, 15, 12, 10, 9, 8, 7, 6, 5, 4, or 3 layers. Combinations of any two of these upper and/or lower values can provide a range selection, for example between about 2 layers to about 20 layers, or about 2 layers to about 10 layers, e.g. about 2 layers to about 7 layers, e.g. about 5 layers.

In some embodiments, at least one of the layers comprise a blend of a starch-based thermoplastic resin and polybutylene adipate terephthalate (PBAT), and at least one of the layers comprises a biopolymer layer.

In other embodiments, at least one of the layers comprises or consists of a blend of a starch-based thermoplastic resin and polybutylene adipate terephthalate (PBAT), and at least one of the layers comprises or consists of polybutylene adipate terephthalate (PBAT).

The multilayered film may comprise at least a first film layer and at least a second film layer. The first film layer may comprise or consist of a blend of a starch-based thermoplastic resin and polybutylene adipate terephthalate (PBAT). The second film layer may comprise or consist of a biopolymer. Alternatively, the second film layer may comprise or consist of polybutylene adipate terephthalate (PBAT). In one embodiment, the multilayered film comprises a first film layer comprising or consisting of a blend of a starch-based thermoplastic resin and polybutylene adipate terephthalate (PBAT) and a second film layer comprising or consisting of polybutylene adipate terephthalate (PBAT). It will be appreciated that additional layers may be present in the multilayered film along with the first film layer and second film layer, which may include one or more intervening film layers between the first and second film layer. Unless expressly defined, no limitation is placed on the location of the first film layer and the second film layer in the multilayered film, and one or more layers may be located either side of the first and second film layers, including intervening between the first and second film layers.

In some embodiments, the multilayered film comprises two or more alternating layers of the first film layer comprising or consisting of a blend of a starch-based thermoplastic resin and polybutylene adipate terephthalate (PBAT) and the second film layer comprising or consisting of a biopolymer. In other embodiments, the multilayered film comprises two or more alternating layers of the first film layer comprising or consisting of a blend of a starch-based thermoplastic resin and polybutylene adipate terephthalate (PBAT) and the second film layer comprising or consisting of polybutylene adipate terephthalate (PBAT). It will be appreciated that the first and second film layers can alternate within the multilayered film whilst still having one or more intervening layers present between them. In other words, the first and second film layers are not required to be immediately adjacent to each other to be considered alternating. This may be the case where one or more intervening layers are present between the first and second film layers. It will be also appreciated that provided there is an alternating motif within the multilayered film, there is no limitation as to what film layer ends up being the outer layers of the multilayered film. For example, the multilayered film may comprise an alternating layer of the first film layer comprising or consisting of a blend of starch-based thermoplastic resin (e.g. layer B) and the second film layer comprising or consisting of polybutylene adipate terephthalate (PBAT) (e.g. layer A), having the alternating structure ABABA.

In one embodiment, the first film layer is a core film layer comprising or consisting of a blend of a starch-based thermoplastic resin and polybutylene adipate terephthalate (PBAT), wherein the core film layer is coated on opposing sides with the second film layer. The second film layer may comprise or consist of a biopolymer. Alternatively, the second film layer may comprise or consist of polybutylene adipate terephthalate (PBAT). In one embodiment, the first film layer is a core film layer comprising or consisting of a blend of a starch-based thermoplastic resin and polybutylene adipate terephthalate (PBAT), wherein the core film layer is coated on opposing sides with the second film layer comprising or consisting of polybutylene adipate terephthalate (PBAT). In one embodiment, at least one of the second film layers is further coated with a third film layer comprising or consisting of a blend of a starch-based thermoplastic resin and polybutylene adipate terephthalate (PBAT). One or more intervening layers may be present between each of the core film layers and the first film layer and/or between the first film layer and the second film layer. In one embodiment, the third film layer is further coated with a fourth film layer comprising or consisting of a biopolymer. In another embodiment, the third film layer is further coated with a fourth film layer comprising or consisting of polybutylene adipate terephthalate (PBAT).

The multilayered film comprises an outer film layer. The term outer film layer refers to a film layer that is at the outer surface of the film. The outer surface may be defined as an exterior outer surface based on the perspective of an external user (for example the outer surface of a cling film facing the environment once applied to cover an opening of a bowl) or an internal outer surface based on the perspective of an external user (for example the inner surface of a cling film facing the contents of in a bowl once applied to cover the opening).

In one embodiment, the multilayered film comprises:
a) a first outer film layer comprising or consisting of a biopolymer;
b) a second outer film layer comprising or consisting of a biopolymer; and
c) at least one inner film layer located between the first outer film layer and the second outer film layer, the inner film layer comprising or consisting of a blend of a starch-based thermoplastic resin and polybutylene adipate terephthalate (PBAT).

In another embodiment, the multilayered film comprises:
a) a first outer film layer comprising or consisting of PBAT;
b) a second outer film layer comprising or consisting of PBAT; and
c) at least one inner film layer located between the first outer film layer and the second outer film layer, the inner film layer comprising or consisting of a blend of a starch-based thermoplastic resin and polybutylene adipate terephthalate (PBAT).

It will be appreciated that one or more intervening layers may be present between the first and/or second outer film layer(s) and the at least one inner film layer. In one embodiment, at least one intervening film layer is located between the first and/or second outer film layer and the at least one inner film layer. In one embodiment, at least two intervening layers are located between an outer film layer and the inner film layer. In some embodiments, the inner film layer comprises a core film layer comprising or consisting of a biopolymer layer coated on opposing sides with the first film layer comprising or consisting of a blend of a starch-based thermoplastic resin and polybutylene adipate terephthalate (PBAT). In other, embodiments, the inner film layer comprises a core film layer comprising or consisting of polybutylene adipate terephthalate (PBAT) coated on opposing sides with the first film layer comprising or consisting of a blend of a starch-based thermoplastic resin and polybutylene adipate terephthalate (PBAT).

In an embodiment, the multilayered film comprises five film layers having the structure ABABA, wherein A is a film layer comprising or consisting of a biopolymer and B is a film layer comprising or consisting of a blend of a starch-based thermoplastic resin and polybutylene adipate terephthalate (PBAT). Alternatively, A may be a film layer comprising or consisting of polybutylene adipate terephthalate (PBAT). In one embodiment, the multilayered film comprises five film layers having the structure ABABA, wherein A is a film layer comprising or consisting of polybutylene adipate terephthalate (PBAT) and B is a film layer comprising or consisting of a blend of a starch-based thermoplastic resin and polybutylene adipate terephthalate (PBAT).

According to at least some embodiments or examples described herein, the inventors have identified that by having outer layers of biopolymer or PBAT, the overall films strength and resistance to tearing increases whilst retaining good compostable/biodegradable properties, along with enhanced cling properties due to the outer biopolymer or PBAT layer(s). Furthermore, the presence of the internal core layer of biopolymer or PBAT provides further advantages such as anti-slip properties during manufacture.

It will be appreciated that each of the first film layer, third film layer, core film layer, inner film layer, and B film layer described herein may comprise a blend of starch-based thermoplastic resin and polybutylene adipate terephthalate (PBAT), including in the amounts and ratios, as described herein in relation to the film. It will also be appreciated that each of the second film layer, fourth film layer, first outer film layer, second outer film layer, intervening film layer, and A film layer described herein may independently comprise a biopolymer or PBAT, including amounts and ratios, as described herein in relation to the film.

In one embodiment, the multilayered film may comprise at least about 30, 35, 40, 45, 50, 55, 60, 65 70 or 75% w/w of the starch-based thermoplastic resin. In some embodiments, the multilayered film may comprise less than about 75, 70, 65, 60, 55, 50, 45, 40, 35 or 30% w/w of the starch-based thermoplastic resin. Combinations of any two of these upper and/or lower values can provide a range selection, for example between about 20% w/w to about 50% w/w, or about 30% w/w to about 50% w/w of the starch-based thermoplastic resin. In some embodiments, the multilayered film comprises about 35% w/w of the starch based thermoplastic resin. In some embodiments, the multilayered film may comprise at least about 20, 25, 30, 35, 40, 45, 50, 55, 60, 65 or 70% w/w of PBAT. In some embodiments, the multilayered film may comprise less than about 70, 65, 60, 55, 50, 45, 40, 35, 30, 25 or 20% w/w of PBAT. Combinations of any two of these upper and/or lower values can provide a range selection, for example between about 50% w/w to about 80% w/w, or about 40% to about 80% w/w of PBAT. In some embodiments, the multilayered film comprises about 65% w/w of PBAT. In some embodiments, the multilayered film may comprise between about 20% w/w to about 50% w/w of the starch-based thermoplastic resin and between about 50% w/w to about 80% w/w of PBAT.

In some embodiments, the multilayered film may comprise at least about 1, 2, 3, 4, 5, 6, 7, 8, 9, 10, 12, 14, 16, 18 or 20% w/w biopolymer. In some embodiments, the multilayered film may comprise less than about 20, 18, 16, 14, 12, 10, 9, 8, 7, 6, 5, 4, 3, 2, or 1% w/w biopolymer. Combinations of any two of these upper and/or lower values can provide a range selection, for example between about 5% w/w to about 20% w/w biopolymer. In one embodiment, the multilayered film comprises about 10% w/w biopolymer.

In some embodiments, each biopolymer or PBAT layer independently makes up less than about 20, 15, 10, 9, 8, 7, 6, 5, 4, 3 or 2% w/w of the multilayered film. In some embodiments, each layer comprising or consisting of a blend of starch-based thermoplastic resin and PBAT independently makes up at least about 35, 37, 40, 42, 45, 47, 48 or 49% w/w of the multilayered film. In one embodiment, the multilayered film comprises about 10/0% w/w biopolymer and about 90% w/w of a blend of starch-based thermoplastic resin and PBAT.

In one embodiment, the multilayered film comprises at least five film layers having the structure ABABA, wherein A is a film layer comprising or consisting of PBAT and B is a film layer comprising or consisting of a blend of a starch-based thermoplastic resin and polybutylene adipate terephthalate (PBAT).

In one embodiment, each A film layer comprising or consisting of PBAT may independently make up between about 5% w/w to about 15% w/w of the multilayered film. In one embodiment, each A film layer comprising or consisting of PBAT may independently make up at least about 5, 6, 7, 8, 9, 10, 11, 12, 13, 14 or 15% w/w of the multilayered film. In one embodiment, each A film layer comprising or consisting of PBAT may independently make up less than about 15, 14, 13, 12, 11, 10, 9, 8, 7, 6, or 5% w/w of the multilayered film. Combinations of any two of these upper and/or lower values can provide a range selection, for example each A film layer comprising or consisting of PBAT may independently make up between about 8% w/w to about 12% w/w of the multilayered film. In one embodiment, each A film layer comprising or consisting of PBAT may independently make up about 10% w/w of the multilayered film.

In one embodiment, each B film layer comprising or consisting of a blend of starch-based thermoplastic resin and PBAT independently makes up between about 30% w/w to about 50% w/w of the multilayered film. In one embodiment, each B film layer comprising or consisting of a blend of starch-based thermoplastic resin and PBAT independently makes up at least about 30, 32, 34, 36, 38, 40, 42, 44, 46, 48 or 50% w/w of the multilayered film. In one embodiment, each B film layer comprising or consisting of a blend of starch-based thermoplastic resin and PBAT independently makes up less than about 50, 48, 46, 44, 42, 40, 38, 36, 34, 32 or 30% w/w of the multilayered film.

Combinations of any two of these upper and/or lower values can provide a range selection, for example, each B film layer comprising or consisting of a blend of starch-based thermoplastic resin and PBAT may independently make up between about 30% w/w to about 40% w/w of the multilayered film. In one embodiment, each B film layer comprising or consisting of a blend of starch-based thermoplastic resin and PBAT independently makes up about 35% w/w of the multilayered film.

In one embodiment, the multilayered film comprises at least five film layers having the structure ABABA, wherein A is a film layer comprising or consisting of PBAT and B is a film layer comprising or consisting of a blend of a starch-based thermoplastic resin and polybutylene adipate terephthalate (PBAT), wherein each A film layer comprising or consisting of PBAT may independently make up between about 5% to about 15% w/w of the multilayered film, and each B film layer comprising or consisting of a blend of starch-based thermoplastic resin and PBAT independently makes up between about 30% w/w to about 50% w/w of the multilayered film.

In one embodiment, each A film layer comprising or consisting of PBAT may make up about 10% w/w of the multilayered film, and each B film layer comprising or consisting of a blend of starch-based thermoplastic resin and PBAT may make up about 35% w/w of the multilayered film.

In one embodiment, the multilayered film comprises at least five film layers having the structure ABABA, wherein A is a film layer comprising or consisting of PBAT and B is a film layer comprising or consisting of a blend of a starch-based thermoplastic resin and polybutylene adipate terephthalate (PBAT).

The multilayered film may be a pallet wrap, cling film and/or stretch wrap. In one embodiment, the multilayered film is a pallet wrap. It will be appreciated that the embodiments and examples described herein in relation to the multilayered film equally apply to pallet wraps, cling films and/or stretch wraps comprising the multilayered film.

### Starch-Based Thermoplastic Resin

The film comprises a starch-based thermoplastic resin. The term “starch-based thermoplastic resin” refers to a starch-based material that softens or melts so as to become pliable, malleable, etc., when exposed to sufficient heat and generally returns to its original condition when cooled to room temperature. In other words, the starch-based thermoplastic resin is a starch based material that will soften and flow on the application of heat. Thermoplastic resins differ from thermosetting resins. Whereas thermoplastic resins can be repeatedly melted and cooled, thermosetting resins, once formed and cured will not re-melt to allow re-moulding or re-use of the material.

The starch-based thermoplastic resin may comprise any suitable starch may be used, including a mixture of starches. In some embodiments, the starch-based thermoplastic resin may comprise one or more starches produced from one or more plants, such as corn starch, tapioca starch, cassava starch, wheat starch, potato starch, rice starch, sorghum starch, and the like. In some embodiments, the starch-based thermoplastic resin may comprise a mixture of different starches. In some embodiments, the starch-based thermoplastic resin may comprise a plasticiser. Additionally, an amount of water can be present in the starch-based thermoplastic resin. A mixture of starches may be provided.

The starch-based thermoplastic resin may comprise any suitable amount of starch. In some embodiments, the starch-based thermoplastic resin may comprise starch in an amount of at least about 50, 55, 60, 65, 70, 75, 80, 85, 90, 95, or 99% w/w of the starch-based thermoplastic resin. In some embodiments, the starch-based thermoplastic resin may comprise less than about 99, 95, 90, 85, 80, 75, 70, 65, 60, 55, or 50% w/w of the starch-based thermoplastic compositions. Combinations of any two of these upper and/or lower % w/w values can provide a range selection, for example between about 60% w/w to about 99% w/w, or about 65% w/w to about 90% w/w. Other than negligible water content, the balance of the starch-based thermoplastic resin may be attributed to the plasticiser (e.g., glycerin).

The starch-based thermoplastic resin may comprise a small residual amount of water (i.e. a moisture content). In some embodiments, the starch-based thermoplastic resin has a moisture content of less than about 10, 9, 8, 7, 6, 5, 5.5, 4, 4.5, 3, 2.5, 2, 1.5, 1.4, 1.3, 1.2, 1.1, 1, 0.9, 0.8, 0.7, 0.6 or 0.5% v/w water, typically less than 2% v/w, e.g. 1% v/w or less. More preferably, the starch-based thermoplastic resin may have a low moisture content (e.g. water content). For example, the starch-based thermoplastic resin may have a moisture content of between about 50 ppm to about 500 ppm. In some embodiments, the starch-based thermoplastic resin has a moisture content (in ppm) of at least about 50, 70, 100, 150, 200, 250, 300, 350, 400, 450 or 500. In some embodiments, the starch-based thermoplastic resin has a moisture content (in ppm) of less than about 500, 450, 400, 350, 300, 250, 200, 150, 100, 70 or 50. Combinations of any two of these upper and/or lower ppm values can provide a range selection, for example between about 50 ppm to 250 ppm. The starch-based thermoplastic resin may be dried to obtain the desired moisture content, for example using a desiccant dryer. Water content can be measured using test method ASTM D6890.

The starch-based thermoplastic resin may comprise a plasticiser. In some embodiments, the starch-based thermoplastic resin may comprise a plasticiser in an amount of at least about 10, 12, 15, 18, 20, 22, 24, 26, 28, 30, 32 or 35% w/w of the starch-based thermoplastic resin. In some embodiments, the starch-based thermoplastic resin may comprise a plasticiser in an amount of less than about 35, 32, 30, 28, 26, 24, 22, 20, 18, 15, 12 or 10% w/w of the starch-based thermoplastic resin. Combinations of any two of these upper and/or lower % w/w values can provide a range selection, for example about 10% w/w to about 35% w/w of the starch-based thermoplastic resin.

If present, the plasticiser may be selected from any suitable plasticiser. In some embodiments, the plasticiser is selected from the group consisting of glycerin, polyethylene glycol, sorbitol, polyhydric alcohol plasticizers, hydrogen bond forming organic compounds which do not have a hydroxyl group, anhydrides of sugar alcohols, animal proteins, vegetable proteins, aliphatic acids, phthalate esters, dimethyl and diethylsuccinate and related esters, glycerol triacetate, glycerol mono and diacetates, glycerol mono, di, and tripropionates, butanoates, tearates, lactic acid esters, citric acid esters, adipic acid esters, stearic acid esters, oleic acid esters, other acid esters, or combinations thereof. In one embodiment, the plasticiser is glycerin.

In some embodiments, the starch-based thermoplastic resin may comprise a mixture of starches. The mixture of starches may comprise a starch present in the mixture in an amount of at least about, 2, 3, 4, 5, 10, 15, 20, 25, 30, 35, 40, 45, 50, 55, 60, 65, 70, 75, 80, 85, 90, or 95% w/w. The mixture of starches may comprise a starch present in the mixture in an amount of less than about 95, 90, 85, 80, 75, 70, 65, 60, 55, 50, 45, 40, 35, 30, 25, 20, 15, 10, 5, 4, 3, 2 or 1% w/w. Combinations of any two of these upper and/or lower % values can provide a range selection, for example between about 10% w/w to about 50% w/w, about 30% w/w to about 35% w/w, about 45% w/w to about 55% w/w or about 70% w/w to about 80% w/w. For example, a mixture of starches may comprise about 90% w/w of a first starch, and about 10% w/w of a second starch, or about 30% w/w of a first starch and about 70% w/w of a second starch, or about 50% w/w of a first starch and about 50% w/w of a second starch. Mixtures of more than two starches (e.g., using 3 or 4 different starches) can also be used. In one embodiment, the starch-based thermoplastic resin comprises starch and glycerin.

The starch-based thermoplastic resin may have a density of at least 1, 1.2, 1.4, 1.5, 1.6, 1.8 or 2 g/cm³. The starch-based thermoplastic resin may have a density of less than 2, 1.8, 1.6, 1.5, 1.4, 1.2 or 1 g/cm³. Combinations of any two of these upper and/or lower density values can provide a range selection, for example between about 1.2 g/cm³ to about 1.6 g/cm³, or about 1.4 g/cm³ to about 1.5 g/cm³, e.g. about 1.4 g/cm³ or about 1.42 g/cm³. The density may be measured using any suitable method, including test method ASTM D792, GB/T 1633 or ISO 1183.

The starch-based thermoplastic resin may have a melt flow index (200° C./5 kg) of at least 1.2, 1.4, 1.6, 1.8, 2, 2.2, 2.4, 2.6, 2.8 g/10 min. The starch-based thermoplastic resin may have a melt flow index (200° C./5 kg) of less than 2.8, 2.6, 2.4, 2.2, 2, 1.8, 1.6, 1.4, or 1.2 g/10 min. Combinations of any two of these upper and/or lower values can provide a range selection, for example between about 1.9 to 2.0 g/10 min. In some embodiments, the starch-based thermoplastic resin has a melt flow index (200° C./5 kg) of about 1.95 g/10 min or about 1.98 g/10 min. The melt flow index may be measured using any suitable method, including test method ASTM D1238, GB/T 3682-2000 or ISO 1133.

The starch-based thermoplastic resin may have a melting temperature range of between about 150° C. to 200° C., about 160° C. to about 190° C., or about 165° C. to about 180° C., for example between about 166° C. to about 180° C. The melting temperature range may be measured using any suitable method, including test method ASTM D3418 or ISO11357. The starch-based thermoplastic resin may have a glass transition temperature of between about 70° C. to about 100° C. Glass transition temperature can be indicative of degree of crystallinity. The glass transition temperature may be measured using any suitable method, including test method ASTM D3418.

The starch-based thermoplastic resin may have a tensile strength at yield of greater than about 10, 12, 14, 16, 18, 20, 22, 24, 26, 28 or 30 MPa. The starch-based thermoplastic resin may have a tensile strength at break of greater than about 10, 12, 14, 16, 18, 20, 22, 24, 26, 28 or 30 MPa. The tensile strength at yield or break may be measured by any suitable method, including test method ASTM D638, GB/T 1040.3-2006 or ISO 527. The starch-based thermoplastic resin may have a Young's modulus of between about 1.0 to 2.0 GPa, for example between about 1.2 to 1.8 GPa, for example about 1.5 GPa. The Young's modulus may be measured by any suitable method, including test method ASTM D638.

The starch-based thermoplastic resin may have an elongation at break of less than about 10%. Elongation at break may be measured using any suitable method, including test method ASTM D882, ASTM D638, GB/T 1040.3-2006 or ISO 527.

The starch-based thermoplastic resin may have a dart impact resistance of between about 3 kg to about 5 kg, for example about 3, 3.5, 4, 4.5 or 5 kg. Dart impact resistance may be measured by any suitable method, including test method ASTM D5628. The starch-based thermoplastic resin may be amorphous (i.e. comprise less than about 10% crystalline properties).

In some embodiments, the starch-based thermoplastic resin may have a crystallinity of less than about 40, 45, 40, 25, 20, 15, 10, 9, 8, 7, 6, 5, 4, or 3%. Suitable methods to determine crystallinity include X-ray diffraction analysis (XRD).

In one embodiment, the starch-based thermoplastic resin is available from BioLogiQ under the tradename NuPlastiQ. Specific examples include, but are not limited to, NuPlastiQ GP and NuPlastiQ CG. NuPlastiQ may be provided in pellet form. In one embodiment, the starch-based thermoplastic resin is NuPlastiQ GP.

### Polybutylene Adipate Terephthalate (PBAT)

The films described herein comprise polybutylene adipate terephthalate (PBAT). PBAT is a biodegradable polymer that can break down in soil environments, and is a copolyester of adipic acid, 1,4-butanediol and terephthalic acid. The structure of PBAT is provided below:

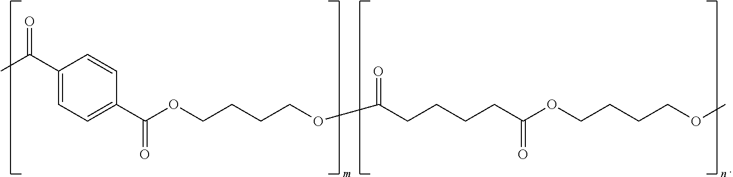

While PBAT demonstrates good biodegradable properties, it is still sourced from petrochemical sources (e.g. made from oil). The present inventors have identified that blending PBAT with a starch-based thermoplastic resin at high ratios of starch-based thermoplastic resin to PBAT (e.g. 0.9 or higher) can be used to prepare films that are not only compostable, but dilutes the overall oil petroleum component in the film which leads to a more sustainable alternative, whilst retaining excellent elongation (i.e. “stretchiness”) and cling properties for use as a wrap composition (e.g. pallet wrap or cling film).

The PBAT may have a density of at least about 1, 1.2, 1.4, 1.6, 1.8 or 2 g/cm³. In some embodiments, the PBAT may have a density of less than about 2, 1.8, 1.6, 1.4, 1.2 or 1 g/cm³. Combinations of any two of these upper and/or lower values can provide a range selection, for example between about 1 to 2 g/cm³, or about 1 to 1.5 g/cm³. In some embodiments, the PBAT may have a density of between about 1.2 to 1.3 g/cm³, for example about 1.2, 1.21, 1.22, 1.23, 1.24, 1.25, 1.26, 1.27, 1.28, 1.29 or 1.3 g/cm³. The density may be measured using any suitable method, including test method ASTM D792 or ISO 1183.

The PBAT may have a melt flow index (190° C./2.1 kg) of at least 2, 2.5, 3, 3.5, 4, 4.5 or 5 g/10 min. The PBAT may have a melt flow index (190° C./2.1 kg) of less than 5, 4.5, 4, 3.5, 3, 2.5 or 2 g/10 min. Combinations of any two of these upper and/or lower values can provide a range selection, for example between about 2.5 to 4.5 g/10 min. The melt flow index may be measured using any suitable method, including test method ASTM D1238 or ISO 1133. The PBAT may have a melting temperature range of between about 100° C. to 150° C., about 110° C. to about 130° C., or about 110° C. to about 120° C., for example between about 116° C. to about 122° C. The melting temperature range may be measured using any suitable method, including test method ASTM D3418 or ISO11357.

The PBAT may have a tensile strength of greater than about 10, 15, 20, 25, 30, or 35 MPa. The PBAT may have a tensile strength at break of greater than about 25 MPa. The tensile strength at yield or break may be measured by any suitable method, including test method ASTM D882, ASTM D638, GB/T 1040.3-2006 or ISO 527. The PBAT may have an elongation at break greater than 200, 250, 300, 350, 400, 450, or 500%, for example greater than about 400%. Elongation at break may be measured using any suitable method, including test method ASTM D882, ASTM D638, GB/T 1040.3-2006 or ISO 527.

The PBAT may comprise a small residual amount of water. In some embodiments, the PBAT has a moisture content of less than about 1, 0.8, 0.6, 0.4, 0.2, 0.1, 0.08, 0.06, 0.04 or 0.02% v/w water, typically less than 0.1% v/w, e.g. 0.06% v/w or less. Water content can be measured using test method ASTM D6890.

### Biopolymer

While not required, in some embodiments, the film comprises a biopolymer. A “biopolymer” as used herein refers to a polymer comprising at least one monomer synthesized via bacterial transformation. This may be blended with the starch-based thermoplastic resin and PBAT or provided as a separate layer (i.e. as part of a multilayered film). According to some embodiments or examples, further advantages are provided by including a biopolymer (such as polybutylene succinate (PBS)) with the blend or as a separate layer, including increasing the films resistance to tearing and rupturing whilst maintaining good elongation (e.g. stretch) and compostable and/or biodegradable properties.

In some embodiments, the biopolymer may be a polyester. The polyester may be selected from the group consisting of polylactic acid (PLA), polybutylene succinate (PBS) and polyhydroxyalkanoate (PHA). In one embodiment, the biopolymer is polybutylene succinate (PBS).

The biopolymer may comprise a small residual amount of water. In some embodiments, the biopolymer has a moisture content of less than about 1, 0.8, 0.6, 0.4, 0.2, 0.1, 0.08, 0.06, 0.04 or 0.02% v/w water, typically less than 0.1% v/w, e.g. 0.06% v/w or less. Water content can be measured using test method ASTM D6890.

### Additives

The film or blend may comprise one or more additives. In one embodiment, the blend comprising or consisting of the starch-based thermoplastic resin and PBAT further comprises the one or more additives. In some embodiments, the one or more additives may be included in the blend in an amount of at least about 0.5, 1, 1.5, 2, 2.5, 3, 3.5, 4, 4.5, 5, 6, 7, 8, 9, 10, 12 or 15% w/w of the blend. In some embodiments, the one or more additives may be included in the blend in an amount of less than 15, 12, 10, 9, 8, 7, 6, 5, 4.5, 4, 3.5, 3., 2.5, 2, 1.5, 1 or 0.5% w/w of the blend. Combinations of any two of these upper and/or lower values can provide a range selection, for example between about 1% to about 10% w/w of the blend.

The film or blend may comprise one or more additives. The additives may be selected from one or more one of a filler, an oil, a strength additive, slip additive, a cling additive, a plasticizer, a colouring additive, a degradation additive, and a compatibilizer.

In one embodiment, the film or blend further comprises an oil. The oil may be a residual amount of oil introduced to the film or blend as part of the PBAT. In some embodiments, the film or blend may comprise less than about 20, 19, 18, 17, 16, 15, 14, 13, 12, 11, 10, 9, 8, 7, 6, 5, 5.5, 4, 4.5, 3, 2.5, 2, 1.5, 1.4, 1.3, 1.2, 1.1, 1, 0.9, 0.8, 0.7, 0.6 or 0.5% w/w oil. Combinations of any two of these % w/w values can provide a range selection, for example the film or blend may comprise between about 2% w/w to about 20% w/w oil, e.g. between about 5% w/w to about 20% w/w oil.

The film or blend may comprise a filler and/or strength additive. In one embodiment, the blend of starch-based thermoplastic resin and PBAT further comprises a filler and/or strength additive. The filler and/or strength additive may comprise material particulates that can improve specific properties in the film, for example tensile strength, elastic modulus, impact resistance, wear resistance, thermal deformation etc. In one embodiment, the filler and/or strength additive may be selected from the group comprising silicates, carbonates and oxides. In one embodiment, the filler and/or strength additive may be selected from the group consisting of mica, feldspar, kaolin, quartz, alkali silicates, alkaline earth silicates, metal oxides, transition metal oxides, and alkali carbonates, alkaline earth carbonates and ammonium carbonate. In some embodiments, the filler and/or strength additive may be an inorganic material selected from group consisting of metal oxides, transition metal oxides and alkaline earth metal. In one embodiment, the filler may comprise titanium (IV) dioxide or calcium carbonate. The filler and/or strength additive may be blended with the starch-based thermoplastic resin and PBAT.

The film or blend may comprise a slip additive. A slip additive can reduce blocking when the films are wound and to reduce or control the peel force of the film when applied to a solid surface. The slip additive may be added as part of the blend or as a separate extruded layer (i.e. part of a multilayered film). The slip additive may be silica. The slip additive may also be a biopolymer described herein.

The film may comprise a cling additive. The cling additive may be a biopolymer described herein.

The film or blend may comprise a colouring additive. The colouring additive may be a natural or artificial colouring additive. The amount of colouring agent to be added can be determined by visual requirements. Natural colouring agents such as saffron, paprika, beetroot, crocein and carotene are preferably used as colouring agents. Artificial colouring additives include a suitable coloured thermoplastic resin which can form part of the blend comprising or consisting of starch-based thermoplastic resin and PBAT.

The film or blend may comprise a biodegradation additive, which may assist in the biodegradation/composting of the film. However, in some embodiments, it will be appreciated that a degradation agent is not required and the films described herein demonstrate excellent compostable and/or biodegradable properties without requiring one or more external additives. The degradation additive may include any variety of ultraviolet and/or oxygen degradable additives.

The film or blend may comprise a compatibilizer. The role of a compatibilizer is to interact with the two polymers being blended to improve their interfacial adhesion. In one embodiment, the blend of starch-based thermoplastic resin and PBAT further comprises a compatibilizer. The compatibilizer may be any suitable material that improves adhesion within the film, for example a modified polyester (e.g. maleic anhydride grafted polyester such as maleic anhydride grafted PBAT or PLA), an acrylate based co-polymer, or a poly(vinylacetate). In one embodiment, no compatibilizer is present.

### Film Properties

The inventors have developed films that can be used as a wrap (e.g. stretch wrap, pallet wrap etc.) that are biodegradable and/or compostable whilst maintaining excellent stretch and/or adhesion properties. This is achieved by extruding the blend of a high ratio of starch-based thermoplastic resin and PBAT to form the film.

In some embodiments, the film is compostable. The term “compostable” as used herein with regard to the film means that the film with comprises a blend of starch-based thermoplastic resin and PBAT composts to base elements such as carbon dioxide, methane (e.g. biomass) and/or water under conditions such as those described herein. Typical compostability standards require at least 90% biodegradation of the polymeric content of the film within 180 days (i.e. reaching 90% biodegradation as measured under ASTM D6400. It will be appreciated that similar standards may be applicable under other certification or regulatory authorities, e.g. under EN13232).

The inventors have surprisingly discovered that, in some embodiments, the films described herein demonstrate enhanced compostability as a result of preparing films comprising the blend of starch-based thermoplastic resin and PBAT described herein. In some embodiments, at least 90, 91, 92, 93, 94 or 95% by weight of the film is compostable within a period of 365, 300, 200, 180, 120, 110, 100 or 90 days. In one embodiment, at least 90% by weight of the film is home and/or industrial compostable within 100 days, significantly faster than 180 days required by conventional standards.

Surprisingly, this enhanced compostability does not compromise the wraps strength, clinginess and stretch properties. The compostability can be measured by any suitable standard, for example test method ASTM D6400. In one embodiment, the compostability is measured using the test method ASTM D6400, but at a lower temperature of 28° C.

The film may have strength characteristics that can be characterised through testing. In some embodiments, the film has a tensile elongation at break test value in the machine direction (MD) of at least about 200, 300, 400, 450, 500, 550, 600, 650, 700, 750, or 800%. In some embodiments, the film has a tensile elongation at break test value in the machine direction (MD) of less than about 800, 750, 700, 650, 600, 550, 500, 450, 400, 300 or 200%. Combinations of any two of these upper and/or lower values can provide a range selection, for example between about 400% to about 800%. In some embodiments, the film has a tensile elongation at break test value in the transverse direction (TD)) of at least about 400, 450, 500, 550, 600, 650, 700, 750, or 800%. Combinations of any two of these upper and/or lower values can provide a range selection, for example between about 500% to about 800%. In some embodiments, the film has a tensile elongation at break test value in the transverse direction (TD) of up to 200, 300, 400, 450, 500, 550, 600, 650, 700, 750, or 800%, e.g. up to 500%. Elongation at break may be measured using any suitable method, including test method ASTM D882, ASTM D638, GB/T 1040.3-2006 or ISO 527. In one embodiment, the elongation at break is measured using ASTM D882.

In some embodiments, the film may have a tensile strength in the machine direction (MD) of at least about 5, 8, 10, 12, 14, 16, 18, 20, 22, 25 MPa. In some embodiments, the film may have a tensile strength in the machine direction (MD) of less than 25, 22, 20, 18, 16, 14, 12, 10, 8 or 5 MPA. Combinations of any two of these upper and/or lower values can provide a range selection, for example between about 10 MPa to about 20 MPa. In some embodiments, the film may have a tensile strength in the transverse direction (TD) of at least about 5, 8, 10, 12, 14, 16, 18, 20, 22, 25 MPa. In some embodiments, the film may have a tensile strength in the transverse direction (TD) of less than 25, 22, 20, 18, 16, 14, 12, 10, 8 or 5 MPA. Combinations of any two of these upper and/or lower values can provide a range selection, for example between about 10 MPa to about 20 MPa. The tensile strength may be measured by any suitable method, including test method ASTM D882, ASTM D638, GB/T 1040.3-2006 or ISO 527, for example ASTM D882.

In some embodiments, the film may have a dart drop impact test value of at least about 150, 175, 200, 225, 250, 275, 300, 325, 350, 375 or 400 g. In some embodiments, the film may have a dart drop impact test value of less than about 400, 375, 350, 325, 300, 275, 250, 225 or 200 g. Combinations of any two of these upper and/or lower values can provide a range selection, for example between about 150 g to about 300 g. The dart drop test may be measured using test standard ASTM D 1709.

In some embodiments, the film may have tangential breaking strength in the machine direction (MD) or transverse direction (TD) of at least about 80, 90, 100, 110, or 120 N/mm. In some embodiments, the film may have tangential breaking strength in the machine direction (MD) or transverse direction (TD) of less than 120, 110, 100, 90 or 80 N/mm. Combinations of any two of these upper and/or lower values can provide a range selection, for example between about 100 to about 120 N/mm. The tangential breaking strength may be measured using test method QB/T1130-91.

In some embodiments, the film may have a melt flow index (190° C./2.16 kg) of at least 2, 2.5, 3, 3.5, 4, 4.5, 5, 6, 6.5, or 7 g/10 min. In some embodiments, the film may have a melt flow index (190° C./2.16 kg) of less than 7, 6.5, 6, 5.5, 5, 4.5, 4, 3.5, 3, 2.5 or 2 g/10 min. Combinations of any two of these upper and/or lower values can provide a range selection, for example between about 2 to 7 g/10 min. The melt flow index may be measured using any suitable method, including test method ASTM D1238, GB/T 3682-2000 or ISO 1133.

In some embodiments, the film may have a melting temperature range of between about 100° C. to 200° C., about 110° C. to about 150° C., or about 120° C. to about 130° C. The melting temperature range may be measured using any suitable method, including test method ASTM D3418 or ISO11357. In some embodiments, the film may have a glass transition temperature of between about 70° C. to about 100° C. Glass transition temperature can be indicative of degree of crystallinity. The glass transition temperature may be measured using any suitable method, including test method ASTM D3418.

In some embodiments, the film may have a density of at least 1, 1.2, 1.4, 1.5, 1.6, 1.8 or 2 g/cm³. In some embodiments, the film may have a density of less than 2, 1.8, 1.6, 1.5, 1.4, 1.2 or 1 g/cm³. Combinations of any two of these upper and/or lower density values can provide a range selection, for example between about 1.2 g/cm³ to about 1.6 g/cm³. The density may be measured using any suitable method, including test method ASTM D792, GB/T 1633 or ISO 1183.

In some embodiments, film may comprise a small residual amount of water (i.e. a moisture content). In some embodiments, the film has a moisture content of less than about 10, 9, 8, 7, 6, 5, 5.5, 4, 4.5, 3, 2.5, 2, 1.5, 1.4, 1.3, 1.2, 1.1, 1, 0.9, 0.8, 0.7, 0.6, 0.5, 0.1, 0.05, 0.01, 0.005 or 0.001% v/w water or less, typically less than 2% v/w, e.g. 1% v/w or less. Combinations of these values can provide a range selection, for example between about 0.001 to about 1.5% v/w water. In one embodiment, the film may be substantially free of water. Water content can be measured using test method ASTM D6890.

### Processes for Preparing Films

The blend of starch-based thermoplastic resin and PBAT is used to prepare a film. For example, the starch-based thermoplastic resin and PBAT may undergo an extrusion process to prepare the films. The term “extrusion” or “extruding” refers to a material that has been shaped, molded, formed, etc., by forcing, pressing, pushing, etc., the material through a shaping, forming, etc., device having an orifice, slit, etc., for example, a die. Extrusion may be continuous (producing indefinitely long material) or semi-continuous (producing many short pieces, segments, etc.). To prepare the films disclosed herein, the extrusion process also requires a heating step to melt the starting material (e.g. starch-based thermoplastic resin and PBAT) which then is extruded into a film.

In one aspect, there is provided a process to prepare a film, comprising heating a blend of a starch-based thermoplastic resin and polybutylene adipate terephthalate (PBAT) in an extruder at a temperature effective to melt the blend, and extruding the melted blend through a die to form a film.

The extrusion process may comprise a cast film extrusion process or a blown film extrusion process. In both methods, the resin is first melted by subjecting it to heat and optionally pressure inside an extruder (e.g. a screw extruder) and finally forcing the melt through a narrow slit in a die. The slit may be either a straight line or a circle. The resulting thin film has either the form of a sheet (cast film) or a tube, also called a “bubble” (blown film). As the film comes out of the die, it is cooled and then rolled up on a core.

Prior to extrusion with PBAT, the starch based thermoplastic resin may be dried reduce the moisture content. In some embodiments, the starch-based thermoplastic resin may be dried at a temperature (in ° C.) of between about 30 to 90 prior to extrusion with PBAT. In some embodiments, the starch-based thermoplastic resin may be dried at temperature (in ° C.) of at least about 30, 35, 40, 45, 50, 55, 60, 65, 70, 75, 80, 85 or 90 prior to extrusion with PBAT. In some embodiments, starch-based thermoplastic resin may be dried at a temperature (in ° C.) of less than about 90, 85, 80, 75, 70, 65, 60, 55, 50, 45, 40, 35 or 30 prior to extrusion with PBAT. Combinations of any two of these upper and/or lower temperature values can provide a range selection, for example between about 40° C. to about 80° C. In some embodiments, the starch-based thermoplastic resin may be dried for a period of time of between about 1 hour to 12 hours. In some embodiments, the starch-based thermoplastic resin may be dried for a period of time (in hours) of at least about 1, 2, 3, 4, 5, 6, 7, 8, 9, 10, 11 or 12. In some embodiments, the starch-based thermoplastic resin may be heated for a period of time (in hours) of less than about 12, 11, 10, 9, 8, 7, 6, 5, 4, 3, 2 or 1. Combinations of any two of these upper and/or lower hour values can provide a range selection, for example between about 2 hours to 8 hours. The starch-based thermoplastic resin may be dried in a desiccant drier. Drying the starch-based thermoplastic resin may provide one or more advantages, such as reducing the moisture content prior to extrusion.

In some embodiments, the starch-based thermoplastic resin and PBAT may be fed into a suitable extruder, for example via one or more hoppers. The extruder may be a screw extruder. The starch-based thermoplastic resin and PBAT may each be fed into the same chamber of the extruder or into different chambers of the extruder. The starch-based thermoplastic resin and PBAT may each be fed into the extruder at different times (e.g. through different hoppers, one being introduced into the extruder earlier on along the screw than the other) and extruded to form the film as described herein. Alternatively, the starch-based thermoplastic resin and PBAT may each be feed into the extruder at the same time, for example as a blend.

In one embodiment, the starch-based thermoplastic resin and PBAT is blended together prior to feeding into the extruder. In one embodiment, the starch-based thermoplastic resin and PBAT is compounded into pellets prior to extrusion.

In one embodiment, the process further comprises compounding a starch-based thermoplastic resin and polybutylene adipate terephthalate (PBAT) into pellets comprising a blend of starch-based thermoplastic resin and polybutylene adipate terephthalate (PBAT); and heating the pellets comprising the blend of starch-based thermoplastic resin and polybutylene adipate terephthalate (PBAT) in an extruder at a temperature effective to melt the blend, and extruding the melted blend through a die to form a film.

In one embodiment, the compounding of the starch based thermoplastic resin and polybutylene adipate terephthalate (PBAT) into pellets comprises an extrusion step and a pelletisation step. In one embodiment, the compounding of the starch based thermoplastic resin and polybutylene adipate terephthalate (PBAT) comprises heating a starch-based thermoplastic resin and polybutylene adipate terephthalate (PBAT) in an extruder at a temperature effective to melt and blend the starch-based thermoplastic resin and polybutylene adipate terephthalate (PBAT), and extruding the melted blend through a die to from pellets comprising a blend of starch-based thermoplastic resin and polybutylene adipate terephthalate (PBAT). The pellets comprising the blend of starch-based thermoplastic resin and PBAT may then be heated in an extruder at a temperature effective to melt the blend, and extruding the melted blend through a die to form a film.

The compounding of the starch-based thermoplastic resin and PBAT may be at a temperature (in ° C.) of at least about 130, 135, 140, 145, 150, 155, 160, 165 or 170. In some embodiments, the compounding may be at a temperature (in ° C.) of less than about 170, 165, 160, 155, 150, 145, 140, 135, or 130. Combinations of any two of these upper and/or lower heating temperature values can provide a range selection, for example between 150° C. to about 165° C. In one embodiment, the compounded pellets may be dried at a temperature (in ° C.) of between about 60 to 100.

In one embodiment, the blend of the starch-based thermoplastic resin and PBAT (e.g. pellets comprising the blend) has a low moisture content (e.g. water content). In some embodiments, the blend of the starch-based thermoplastic resin and PBAT has a moisture content of between about 1 ppm to about 500 ppm. In some embodiments, the blend of the starch-based thermoplastic resin and PBAT has a moisture content (in ppm) of at least about 1, 2, 5, 10, 15 20, 25, 30, 40, 50, 70, 100, 150, 200, 250, 300, 350, 400, 450 or 500. In some embodiments, the blend of the starch-based thermoplastic resin and PBAT has a moisture content (in ppm) of less than about 500, 450, 400, 350, 300, 250, 200, 150, 100, 70, 50, 40, 30, 25, 20, 15, 10, 5, 2 or 1. Combinations of any two of these upper and/or lower ppm values can provide a range selection, for example the blend of the starch-based thermoplastic resin and PBAT has a moisture content of between about 1 ppm to about 100 ppm, or between about 1 ppm to 50 ppm. In one embodiment, the blend of the starch-based thermoplastic resin and PBAT has a moisture content of less than about 50 ppm. According to at least some embodiments or examples described herein, having a moisture content within the blend of about 50 ppm or less prior to extrusion can reduce the films degree of crystallinity and thus enhance its elongation properties. In one embodiment, the film may be substantially amorphous (e.g. substantially non-crystalline/substantially free of crystal phases). In one embodiment, the desired moisture content of the blend may be obtained by drying the blend during the compound extrusion step e.g. via venting the extruder which removes moisture from the melted blend prior to pelletisation. (e.g. at atmospheric pressure or under vacuum up to 0.8 MPa or greater).

In some embodiments, the blend (e.g. compounded pellets) may be dried at temperature (in ° C.) of at least about 60, 65, 70, 75, 80, 85, 90, 95 or 100. In some embodiments, the blend (e.g. compounded pellets) may be dried at a temperature (in ° C.) of less than about 100, 95, 90, 85, 80, 75, 70, 65, 60. Combinations of any two of these upper and/or lower temperature values can provide a range selection, for example between about 60° C. to about 90° C. In some embodiments, the blend (e.g. compounded pellets) may be dried for a period of time of between about 1 hour to 12 hours. In some embodiments, the blend (e.g. compounded pellets) may be dried for a period of time (in hours) of at least about 1, 2, 3, 4, 5, 6, 7, 8, 9, 10, 11 or 12. In some embodiments, the blend (e.g. compounded pellets) may be dried for a period of time (in hours) of less than about 12, 11, 10, 9, 8, 7, 6, 5, 4, 3, 2 or 1. Combinations of any two of these upper and/or lower hour values can provide a range selection, for example between about 1 hour to 3 hours. The blend (e.g. compounded pellets) may be dried in a desiccant drier.

In one embodiment, the film is prepared by heating a blend of the starch-based thermoplastic resin and PBAT (e.g. pellets comprising the blend) in an extruder. The heating is at a temperature effective to melt the blend (i.e. melt the starch-based thermoplastic resin and PBAT). The melt can then be extruded through a die to form the film.

The process comprises heating the blend in an extruder at a temperature effective to melt the blend which is then extruded to form the film. In some embodiments, the blend may be heated to a temperature of at least about 100, 105, 110, 115, 120, 125, 130, 135, 140, 145, 150, 155, 160, 165, 170, 175, 180, 185, 190, 195 or 200° C. In some embodiments, the blend may be heated to a temperature of less than about 200, 195, 190, 185, 180, 175, 170, 165, 160, 155, 150, 145, 140, 135, 130, 125, 120, 115, 110, 105 or 100° C. Combinations of any two of these upper and/or lower heating temperature values can provide a range selection, for example between about 120° C. to about 190°, or between about 120° C. to about 180° C., for example between about 125° C. to about 165° C.

The heating of the blend may be within a multistage extruder comprising two or more stages. The multistage extruder may heat the blend to a given temperature in each extruder stage, where progressive stages are heated to higher temperature than the preceding stage. For example, the extruder is a multistage extruder comprising two or more extruder stages, wherein each stage of the extruder is heated to a higher temperature than the preceding stage.

In one embodiment, the extruder is a multistage extruder comprising at least 2, 3, 4, 5, 6, 7, 8, 9 or 10 extruder stages. In one embodiment, the extruder is a multistage extruder comprising at least 4 extruder zones.

In some embodiments, the multistage extruder has an increasing temperature differential across each stage. In some embodiments, the temperature differential across each stage may be between about 100° C. to about 200° C., about 120° C. to about 190° C. or about 160° C. to about 180° C. In some embodiments, each extruder stage may be independently heated to a temperature of at least about 100, 105, 110, 115, 120, 125, 130, 135, 140, 145, 150, 155, 160, 165, 170, 175, 180, 185, 190, 195 or 200° C. In some embodiments, each extruder stage may be independently heated to a temperature of less than 200, 195, 190, 185, 180, 175, 170, 165, 160, 155, 150, 145, 140, 135, 130, 125, 120, 115, 110, 105 or 100° C. Combinations of any two of these upper and/or lower heating temperature values can provide a range selection, for example between about 120° C. to about 190° C.

For example, the multistage extruder may comprise 4 extruder stages. In some embodiments, the first extruder stage may be heated to a temperature of at least about 100, 105, 110, 115, 120, 125, 130, 135 or 140° C. In some embodiments, the first extruder stage may be heated to a temperature of less than about 140, 135, 130, 125, 120, 115, 110, 105 or 100° C. Combinations of any two of these upper and/or lower heating temperature values can provide a range selection, for example between about 100° C. to about 140° C., or about 110° C. to about 130° C. In some embodiments, the first extruder stage may be heated to a temperature of about 100, 105, 110, 115, 120, 125, 130, 135 or 140° C., for example about 120° C. In some embodiments, the second extruder stage may be heated to a temperature of at least about 110, 115, 120, 125, 130, 135, 140, 145 or 150° C. In some embodiments, the second extruder stage may be heated to a temperature of less than about 150, 145, 140, 135, 130, 125, 120, 115, or 110° C. Combinations of any two of these upper and/or lower heating temperature values can provide a range selection, for example between 110° C. to about 150° C., or about 120° C. to about 140° C. In some embodiments, the second extruder stage may be heated to a temperature about 110, 115, 120, 125, 130, 135, 140, 145 or 150° C., for example about 130° C. In some embodiments, the third extruder stage may be heated to a temperature of at least about 120, 125, 130, 135, 140, 145, 150. 155 or 160° C. In some embodiments, the third extruder stage may be heated to a temperature of less than about 160, 155, 150, 145, 140, 135, 130, 125, 120° C. Combinations of any two of these upper and/or lower heating temperature values can provide a range selection, for example between 120° C. to about 160° C., or about 130° C. to about 150° C. In some embodiments, the fourth extruder stage may be heated to a temperature about 120, 125, 130, 135, 140, 145, 150. 155 or 160° C., for example about 140° C. In some embodiments, the forth extruder stage may be heated to a temperature of at least about 130, 135, 140, 145, 150. 155, 160, 165 or 170° C. In some embodiments, the fourth extruder stage may be heated to a temperature of less than about 170, 165, 160, 155, 150, 145, 140, 135, or 130° C. Combinations of any two of these upper and/or lower heating temperature values can provide a range selection, for example between 130° C. to about 170° C., or about 140° C. to about 160° C. In some embodiments, the fourth extruder stage may be heated to a temperature about 130, 135, 140, 145, 150. 155, 160, 165 or 170° C., example about 150° C.

In one exemplary embodiment, the blend comprising the starch-based thermoplastic resin, PBAT and optionally one or more additives are provided by one or more hoppers into the first extruder stage of a multistage extruder (e.g. a single screw or twin screw extruder). The blend can then pass through a number of extruder stages, such as a first, second, third, and fourth extruder stage. The blend can be heated in the extruder stages. In some embodiments, the temperature of one of the extruder stages can be different from the temperature of another one of the extruder stages. For example, the first extruder stage may be heated to a temperature of between about 110° C. to about 130° C.; the second extruder stage may be heated to a temperature of between about 120° C. to about 140° C.; the third extruder stage may be heated to a temperature of between about 130° C. to about 150° C.; and the fourth extruder stage may be heated to a temperature of between about 140° C. to about 160° C.

The extruder may have a rotational speed, for example the screw of the extruder may rotate. The speed of the screw extruder may be at least about 8, 10, 12, 14, 16, 18, 20, 22, 24, 26, 28, 30, 32, 34, 36, 38 or 40 rotations per minute (rpm). The speed of the screw extruder may be less than about 40, 38, 36, 34, 32, 30, 28, 26, 24, 22, 20, 18, 16, 14, 12, 10 or 8 rpm. Combinations of any two of these upper and/or values can provide a range selection, for example between about 8 rpm to about 40 rpm. The blend passes through the extruder as it rotates (owing to the screw design).

The melted blend may pass through an adaptor before being extruded through a die. The adapter guides the melted blend from the screw extruder as quickly and uniformly as possible. Maintaining the temperature of the melted blend when it leaves the extruder on its way to be formed into sheets is allows for the overall properties of the film to be controlled, such as even homogeneity and prevents premature cooling and solidifying of the melted blend. In some embodiments, the adapter may be heated to a temperature of at least about 140, 145, 150. 155, 160, 165, 170, 175 or 180° C. In some embodiments, the adapter may be heated to a temperature of less than about 180, 175, 170, 165, 160, 155, 150, 145, or 140° C. Combinations of any two of these upper and/or lower heating temperature values can provide a range selection, for example between 140° C. to about 180° C., or about 150° C. to about 170° C. In some embodiments, the adapter may be heated to a temperature about 140, 145, 150. 155, 160, 165, 170, 175, or 180° C., example about 160° C. Melt pumps, also called gear pumps, can be attached between the end of the extruder and the die to control the flow of the melt from the extruder to the die.

The melted blend is extruded through a die to form the film. In some embodiments, the die is attached to an adapter. The die ensures smooth and complete melt flow and forces the melted blend into a form approaching its final shape whilst maintaining the melt at a constant temperature. Any suitable die can be used, for example cast film die or blown film die. The die may have any suitable gap in which the melted blend passes through. In some embodiments, the die gap is at least about 0.1, 0.2, 0.3, 0.5, 0.8, 1, 1.2, 1.4, 1.6, 1.8, 2, 2.2, 2.4, 2.6, 2.8, or 3 mm. In some embodiments, the die gap is less than 3, 2.8, 2.6, 2.4, 2.2, 2, 1.8, 1.6, 1.4, 1.2, 1, 0.8, 0.5, 0.3, 0.2 or 0.1 mm. Combinations of any two of these upper and/or lower values can provide a range selection, for example between about 0.5 mm to about 3 mm.

In some embodiments, the die may be heated to a temperature of at least about 140, 145, 150. 155, 160, 165, 170, 175, 180, 190, or 200° C. In some embodiments, the die may be heated to a temperature of less than about 200, 190, 180, 175, 170, 165, 160, 155, 150, 145, or 140° C. Combinations of any two of these upper and/or lower heating temperature values can provide a range selection, for example between about 140° C. to about 200° C., or between about 140° C. to about 180° C., or about 150° C. to about 170° C. In some embodiments, the die may be heated to a temperature about 140, 145, 150. 155, 160, 165, 170, 175, or 180° C., example about 165° C. In some embodiments, the die is heated to a temperature that corresponds to the lowest temperature PBAT will melt and the highest temperature the starch-based thermoplastic resin will melt but not degrade, for example about 165° C.

In one embodiment, where the process is blown film extrusion, the die is a blown film die. In blown film extrusion, the melt enters the die (e.g. round die) either through the bottom or the side. The melt is forced through spiral grooves around the surface of a mandrel inside the die and extruded through the circular die opening in the form of a thick-walled tube. Melt distribution can be improved by lengthening and/or increasing the number of the spiral grooves. The tube, while still in the molten state, is expanded into a long “bubble” of desired diameter and correspondingly decreased thickness. This expansion results from the volume of air inside the bubble, which is introduced into the tube through the center of the mandrel. Blown film dies can have a number of circular heating zones to maintain the die temperature. The blown film die may be position vertically to push the tube upwards. However, there are dies which can extrude downwards.

In one embodiment, there the process is cast film extrusion, the die is a cast film die. The most common cast film dies are keyhole or coat hanger dies. In a keyhole die, the cross section of the manifold is constant. In a coat hanger die, this cross section decreases across the manifold from the centre of the die to the outer edges. The coat hanger die's manifold distributes the incoming melt across a steadily widening flow; then the die land forms the melt into its final thickness before the melt exits the die.

For multilayered films, a coextrusion process may be used. In some embodiments, the process further comprises heating the biopolymer/PBAT in a separate extruder at a temperature effective to melt the biopolymer/PBAT, and co-extruding the melted biopolymer/PBAT with the melted blend through the die to form a multilayered film. For example, the biopolymer/PBAT may be dry blended at a separated extruder, melted and co-extruded with the melted blend through the die to form a multilayered film. The biopolymer/PBAT may be heated in the separate extruder at a temperature described herein in relation to melting the blend of starch-based thermoplastic resin and PBAT. The separate extruder may be a multistage extruder (e.g. screw extruder) as described herein. It will be appreciated that additional extruders may be included to form a multilayered film comprising multiple layers as described herein. For example, in some embodiments, the blend of a starch-based thermoplastic resin and polybutylene adipate terephthalate (PBAT) and the biopolymer/PBAT are independently heated in an extruder at a temperature of between about 120° C. to about 190° C.

In one embodiment, the process does not require additional down-blending, for example further addition of PBAT to the blend during the extrusion. For example, such down blending may increase the amount of PBAT which introduces more synthetic oil petroleum into the final film. Unlike other process which require additional blending, the inventors have identified a simple and effective extrusion process using the high ratio of starch-based thermoplastic resin to PBAT described herein to prepare a film, for example a stretch wrap and pallet wrap, that is compostable and has reduced synthetic oil petroleum content compared to other biodegradable plastic films.

In some embodiments, the process generates between 1 kg/hour to 2 tons/hr of film.

If present, one or more additives may be added with the blend and/or biopolymer/PBAT, or extruded as a separate film layer. It will be appreciated that the embodiments and examples of the blend of starch-based thermoplastic resin and PBAT and biopolymer/PBAT described above in relation to the films equally apply to the process for preparing the films.

In some embodiments, the process further comprises packaging the film into a roll. The roll may be any suitable size. The roll may comprise the film rolled around a tube, for example a cardboard or plastic tube.

### Articles

The inventors have identified that the films described herein are particularly useful as stretch wraps, cling wraps/films and pallet wraps. In one embodiment, the film is a stretch wrap. In one embodiment, the film is a pallet wrap. In one embodiment, the film is a cling film. The cling wrap/film, stretch wrap and pallet wrap comprise a blend of starch-based thermoplastic resin and PBAT. It will be appreciated that the embodiments and examples of the blend of starch-based thermoplastic resin and PBAT and biopolymer/PBAT described above in relation to the films equally apply to cling film, stretch wrap and pallet wraps

### EXAMPLES

In order that the disclosure may be more clearly understood, particular embodiments of the invention are described in further detail below by reference to the following non-limiting experimental materials, methodologies and examples.

### General Materials

All chemicals were used as received. The starch-based thermoplastic resin, NuPlastiQ® GP BioPolymer, was purchased from BioLogiQ. Polybutylene adipate terephthalate (PBAT) was purchased from Pekin Chem. Polybutylene succinate (PBS) was used as received.

### Example 1: Fabrication of Film Comprising 1:1 Starch-Based Thermoplastic Resin to PBAT

A mixture comprising starch-based thermoplastic resin and PBAT in a ratio of 1.0 (e.g. 1:1) was mixed to obtain a homogenous blend. The blend was then heated based on the following temperature profile zones to obtain a melt (all temperatures ° C.; RT=room temperature; all residence times in minutes)

| Zone | 0 | 1 | 2 | 3 | 4 |
|---|---|---|---|---|---|
| Set temperature | RT to 100 | 100 | 120 | 140 | 165 |
| Residence time | 15 | 10 | 10 | 10 | 10 |

After heating at zone 4, the melt was subsequently extruded onto a chilled surface and spread thin to form a film. Once cooled, the film was rolled into a roll. To assess the viability of the film as a stretch wrap following extrusion, cooling and rolling, the film was pulled off the roll after 12 hours and stretched. The film's properties (e.g. stretch, clinginess and durability) was essentially identical based on a visual comparison to a conventional petro-plastic cling wrap.

### Example 2: Fabrication of a Multilayered Film

A multilayered film can be prepared using an SML line 1 comprising four multi-stage extruders capable of producing up to 5 layers at the die. The multilayered film has the structure BADAC, each film layer making up a % w/w of the total multilayered film as outlined in Table 1:

TABLE 1
Components of Multilayered film

| B | A | D | A | C |
|---|---|---|---|---|
| 10% | 35% | 10% | 35% | 10% |

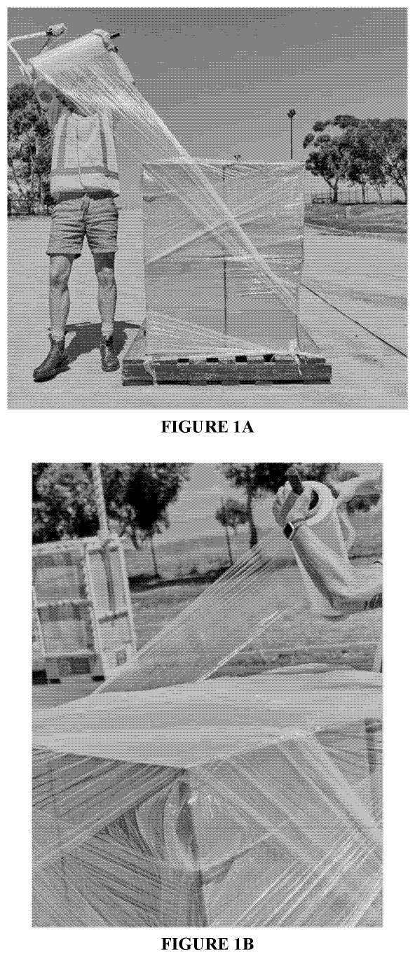

The extruder are operated as follows:
Multi-stage extruder A: Extrudes a film layer comprising previously compounded and pelletized blend of starch-based thermoplastic resin and PBAT (30-80 wt % TPS in PBAT), with a temperature profile starting at 130° C. at the feed end and increasing to 160° C. along the barrel zones;
Multi-stage extruders B, C and D: Extrudes separate film layers comprising 100% PBAT, with a temperature profile of 120° C. at the feed up to 190° C. along the barrel zones.
Die: The die temperature is between 165° C. to 200° C.
   The multilayered film is shown in FIG. 1, which is being applied as a pallet wrap highlighting the films strength and durability properties.

### Example 2: Evaluation of Film Disintegration During Composting

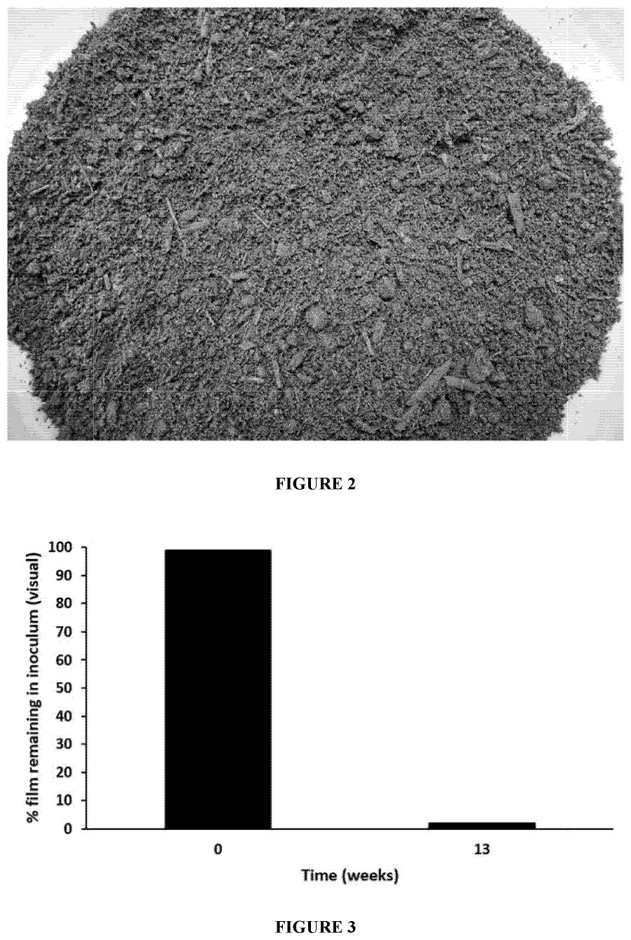

The disintegration at ambient temperature of a single film cling wrap prepared by extruding a 1:1 starch-based thermoplastic resin to PBAT blend was evaluated over 13 weeks. The cling wrap had a thickness of 18 μm, cut into 2.5 cm×2.5 cm pieces, and was mixed in a 0.5% concentration with compost inoculum and the obtained mixture is incubated in the dark at ambient temperatures (28° C.±2° C.). This composting study is based on test method ASTM D6400, but performed at the above ambient temperature as opposed to higher temperatures. The disintegration of the cling wrap proceeded very swiftly. After 91 days (i.e. 13 weeks) of composting, all test item pieces had completely disappeared based on a visual assessment, and no test material could be retrieved from the composting reactors; see FIG. 2. As complete disintegration was obtained and no visual evidence of the cling wrap remained in the compost inoculum. the test was stopped after 91 days of composting instead of the maximum duration of 180 days. FIG. 3 provides a graphical representation of the films disintegration in the inoculum after 91 days highlighting the films excellent compostability.

### Example 3: Evaluation of Film Elongation at Break Properties

The elongation at break of a single film cling wrap prepared by extruding a 1:1 starch-based thermoplastic resin to PBAT blend was evaluated using the test method ASTM D882, as shown in Table 2.

TABLE 2
Elongation at break results of single film cling wrap

| | | | | | | Test 5 |
|---|---|---|---|---|---|---|
| | Start | | | | | before |
| | length | Test 1 | Test 2 | Test 3 | Test 4 | rip |
| Sample 1 | 100 cm | 230 cm | 352 cm | 475 cm | 479 cm | 505 cm |
| Elongation % | 0% | 130% | 252% | 375% | 379% | 405% |
| Sample 2 | 100 cm | 225 cm | 344 cm | 458 cm | 480 cm | 510 cm |
| Elongation % | 0% | 125% | 244% | 358% | 380% | 410% |

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

The present application claims priority from AU 2021900904 filed 26 Mar. 2021, the entire contents of which are incorporated herein by reference.

1. A film comprising a blend having a high ratio of starch-based thermoplastic resin to polybutylene adipate terephthalate (PBAT).

2. The film of claim 1, wherein the ratio of the starch-based thermoplastic resin to PBAT in the blend is at least 0.9.

3. The film of claim 1 or claim 2, wherein the ratio of the starch-based thermoplastic resin to PBAT in the blend is between about 0.9 to 2.0.

4. The film of any one of claims 1 to 3, wherein the ratio of the starch-based thermoplastic resin to PBAT in the blend is about 1.0.

5. A multilayered film comprising at least a first layer comprising a blend of a starch-based thermoplastic resin and polybutylene adipate terephthalate (PBAT) and a second film layer.

6. The multilayered film of claim 5, wherein the second film layer comprises polybutylene adipate terephthalate (PBAT).

7. The multilayered film of claim 5 or claim 6, comprising two or more alternating layers of the first film layer comprising a blend of a starch-based thermoplastic resin and polybutylene adipate terephthalate (PBAT) and the second film layer comprising polybutylene adipate terephthalate (PBAT).

8. The multilayered film of any one of claim 5 or 7, wherein the first film layer is a core film layer comprising a blend of a starch-based thermoplastic resin and polybutylene adipate terephthalate (PBAT), wherein the core film layer is coated on opposing sides with the second film layer comprising polybutylene adipate terephthalate (PBAT).

9. The multilayered film of claim 8, wherein the at least one of the second film layers is further coated with a third film layer comprising a blend of a starch-based thermoplastic resin and polybutylene adipate terephthalate (PBAT).

10. The multilayered film of claim 9, wherein the third film layer is further coated with a fourth film layer comprising or consisting of polybutylene adipate terephthalate (PBAT).

11. A multilayered film comprising:
a) a first outer film layer comprising polybutylene adipate terephthalate (PBAT);
b) a second outer film layer comprising polybutylene adipate terephthalate (PBAT); and
c) at least one inner film layer located between the first outer film layer and the second outer film layer, the inner film layer comprising a blend of a starch-based thermoplastic resin and polybutylene adipate terephthalate (PBAT).

12. The multilayered film of claim 11, wherein at least one intervening film layer is located between the first and/or second outer film layer and the at least one inner film layer.

13. A multilayered film comprising at least five film layers having the structure ABABA, wherein A is a film layer comprising polybutylene adipate terephthalate (PBAT) and B is a film layer comprising a blend of a starch-based thermoplastic resin and polybutylene adipate terephthalate (PBAT).

14. The multilayered film of any one of claims 5 to 13, wherein the wherein the ratio of the starch-based thermoplastic resin to PBAT in the blend is at least 0.9.

15. The multilayered film of any one of claims 5 to 14, wherein the ratio of the starch-based thermoplastic resin to PBAT in the blend is between about 0.9 to 2.0.

16. The multilayered film of any one of claims 5 to 15, wherein the ratio of the starch-based thermoplastic resin to PBAT in the blend is about 1.0.

17. The film of any one of claims 1 to 16, wherein the starch-based thermoplastic resin comprises starch and glycerin.

18. The film of any one of claims 1 to 17, wherein the starch-based thermoplastic resin is NuPlastiQ™ GP BioPolymer.

19. The film of any one of claims 1 to 18, wherein the film has a tensile elongation at break test value in the machine direction (MD) of between about 500% to about 800% measured using test method ASTM D882.

20. The compostable film of any one of claims 1 to 19, wherein the film has a tensile strength in the machine direction (MD) of between about 10 MPa to about 20 MPa measured using test method ASTM D882.

21. The film of any one of claims 1 to 20, wherein at least 90% by weight of the film is compostable within 100 days at 28° C. measured using test method ASTM D6400.

22. The film of any one of claims 1 to 21, wherein the film has a thickness of between about 1 μm to about 2 mm.

23. A stretch wrap comprising the film of any one of claims 1 to 22.

24. A pallet wrap comprising the film of any one of claims 1 to 23.

25. A cling film comprising the film of any one of claims 1 to 24.

26. A process to prepare a film comprising heating a blend of a starch-based thermoplastic resin and polybutylene adipate terephthalate (PBAT) in an extruder at a temperature effective to melt the blend, and extruding the melted blend through a die to form a film.

27. The process of claim 26, wherein the process further comprises compounding a starch-based thermoplastic resin and polybutylene adipate terephthalate (PBAT) into pellets comprising a blend of starch-based thermoplastic resin and polybutylene adipate terephthalate (PBAT); and
heating the pellets comprising the blend of starch-based thermoplastic resin and polybutylene adipate terephthalate (PBAT) in an extruder at a temperature effective to melt the blend, and extruding the melted blend through a die to form a film.

28. The process of claim 27, wherein the compounding of the starch based thermoplastic resin and polybutylene adipate terephthalate (PBAT) into pellets comprises an extrusion step and a pelletisation step.

29. The process of claim 27 or claim 28, wherein the compounding of the starch based thermoplastic resin and polybutylene adipate terephthalate (PBAT) comprises:
heating a starch-based thermoplastic resin and polybutylene adipate terephthalate (PBAT) in an extruder at a temperature effective to melt and blend the starch-based thermoplastic resin and polybutylene adipate terephthalate (PBAT), and
extruding the melted blend through a die to from pellets comprising a blend of starch-based thermoplastic resin and polybutylene adipate terephthalate (PBAT).

30. The process of any one of claims 26 to 29, further comprising heating PBAT in an extruder at a temperature effective to melt PBAT, and co-extruding the melted PBAT with the melted blend through the die to form a multilayered film.

31. The process of claim 30, wherein the blend of a starch-based thermoplastic resin and polybutylene adipate terephthalate (PBAT) and the PBAT are independently heated in an extruder at a temperature of between about 120° C. to about 180° C.

32. The process of any one of claims 26 to 31, wherein the extruder is a multistage extruder comprising two or more extruder stages, wherein each stage of the extruder is heated to a higher temperature than the preceding stage.

33. The process of claim 32, wherein the multistage extruder has an increasing temperature differential across each stage of between about 120° C. to about 190° C.

34. The process of any one of claims 26 to 33, wherein the temperature of the die is between about 140° C. to about 200° C.

35. The process of any one of claims 26 to 34, wherein the ratio of the starch-based thermoplastic resin to PBAT in the blend is at least 0.9.

36. The process of any one of claims 26 to 35, wherein the ratio of the starch-based thermoplastic resin to PBAT in the blend is between about 0.9 to 2.0.

37. The process of any one of claims 26 to 36, wherein the ratio of the starch-based thermoplastic resin to PBAT in the blend is about 1.0.

38. The process of claims 26 to 37, wherein the blend of starch-based thermoplastic resin and polybutylene adipate terephthalate (PBAT) has a moisture content of less than about 50 ppm.

39. The process of any one of claims 26 to 38, further comprising packaging the film into a roll.

40. The process of any one of claims 26 to 39, wherein the film is a stretch wrap, cling film or pallet wrap.

41. A stretch wrap, cling film or pallet wrap prepared by the process of any one of claims 26 to 40.
